(19) United States
(12) Patent Application Publication
(10) Pub. No.: US 2026/0170076 A1
(43) Pub. Date: Jun. 18, 2026

(54) WEBSITE DEPLOYMENT ARTIFACT GENERATION USING TASK-SPECIFIC MACHINE LEARNING PROMPTING

(71) Applicant: Webflow, Inc., San Francisco, CA (US)

(72) Inventors: Thomas Cleveland, Santa Barbara, CA (US); Nathan Selvidge, San Francisco, CA (US); Ryan Carey, New York, NY (US); Katherine Lundsgaard, San Francisco, CA (US); Daniel Zhang, Toronto (CA); Anton Lapshin, Tampa Bay, FL (US); Kourosh Tavakoli, Walnut Creek, CA (US); Rory Davidson, San Francisco, CA (US)

(21) Appl. No.: 19/356,941

(22) Filed: Oct. 13, 2025

Related U.S. Application Data
(60) Provisional application No. 63/707,167, filed on Oct. 14, 2024.
(60) Provisional application No. 63/707,158, filed on Oct. 14, 2024.

(51) Int. Cl. G06F 16/958; G06F 8/35

(52) U.S. Cl. CPC G06F 16/958; G06F 8/35

(57) ABSTRACT

Methods, systems, and apparatus, including computer programs encoded on computer storage media, for dynamically performing website creation. In some implementations, a server receives request data specifying a natural language description of a webpage modification. The server determines web development tasks corresponding to the webpage modification. The server determines web development tools configured to execute the web development tasks. The server generates prompt data for trained machine learning models. The prompt data includes instructions for generating a code update segment for the webpage modification. The server obtains from the trained ML models output data for the code update segment. The code update segment causes the web development tools to execute the tasks. The server generates a deployment artifact by executing the code update segment. The server provides an instruction that causes the computing device to display a representation of a modified webpage based on the deployment artifact.

### CROSS-REFERENCE TO RELATED APPLICATIONS

This application claims the benefit of U.S. Provisional Application Nos. 63/707,158 and 63/707,167, each filed on Oct. 14, 2024, the contents of which are incorporated by reference in their entirety.

### TECHNICAL FIELD

This disclosure generally describes technology relating to machine learning, and more particularly, to technology related to the integration of machine learning to cloud-based software platforms.

### BACKGROUND

Machine learning (ML) enables systems to learn from data and improve their performance without being explicitly programmed for every task. Rather following predefined rules, ML systems build models based on patterns found in large datasets. These models may then make predictions, classify data, or perform decision-making tasks based on new, unseen data. ML may involve providing input data into a trained model, which processes the providing data to identify patterns or relationships within the data.

Machine learning may involve several types of learning. For example, in supervised learning, a model is trained on labeled data, where both the inputs and desired outputs are known. The goal is to learn a mapping from inputs to outputs to make predictions on new, unlabeled data. As another example, in unsupervised learning, a model works with data that has no labeled outcomes. Another example is reinforcement learning, where a model learns by interacting with an environment and receiving feedback in the form of rewards or penalties. ML has applications across industries, including healthcare, finance, and consumer-focused technologies. In the context of healthcare, ML systems and techniques may be useful to predict diseases, analyze medical images, and provide other advantages.

Often, a user may rely on one or more tools to help build, create, or modify their website. Conventional approaches for website creation involving different tools often require the user to learn how to use the tool. This includes learning how to apply the tool, learning how to configure the tool, and learning how to modify the input to the tool to reach a desired output associated with a particular website configuration. This requires time and energy for the user to invest in tool learning that could be otherwise spent building the actual website. This process becomes even more important when a user needs to match a tool's output to specific structure and content, such as in a website creation environment that includes structures and schema rules that must be adhered to. As a result, a user having to learn a tool's functionality for website creation often disrupts the website creation process, which may frustrate a user's experience and delay the website's release to market.

### SUMMARY

This disclosure relates to systems and techniques that dynamically and intelligently performs website creation. In particular, the systems may receive a query from a user for performing a particular task related to website creation. The systems may also rely on ML to process the user query and generate a set of instructions that enable the system to modify the website or create a website's content, structure, or design, according to content of the user query. The set of instructions may represent a set of command based instructions that are executable by a computer system, for example. The systems execute these command based instructions to generate modifiable content related to the website creation, and render the update on a device of the user. By enabling ML models to create the set of command based instructions, this removes the need for direct human manipulation of code in a complex environment. Users seeking to build or modify portions of a website no longer need to write code, invoke tools, or execute specific functions. Instead, as described herein, users may rely on the ML approaches to provide a more intuitive and accessible method for managing and creating web content that would otherwise be ill-afforded and/or timely to create.

To accurately determine instructions that lead to performing actions responsive to user queries, the systems may generate various inputs to provide to one or more trained ML models. For example, in response receiving a user query, a system determines which section or sections of the website the user's requested action refers. The section or sections to which the user's requested action refers allows trained ML models to focus its processing related to that section, in order to generate output related to that section. This “scoped functionality” ensures that processing by one or more ML models is focused and does not cross-pollinate between different sections of a website, especially when the different sections of a website may involve different schema rules, different content, and different structures, to name a few examples.

Additionally, by scoping the user's request to a particular section, the system may retrieve historical data associated with that particular section to improve accuracy of ML model output. For example, the system may retrieve requests that were previously processed against the same section of the website as is referred to in the current user request and provide data representative of those previous requests as part of the input to one or more trained ML models. The addition of historical data as part of the input to the one or more trained ML models provides various technical advantages. First, the one or more trained ML models may maintain track of previous actions performed by the system related to that section. Second, ML model outputs maintain continuity across the previous requests to the current request for similar requests. This continuity ensures the one or more trained ML models preserve similar edits, content, structure, and similar schema rules across each request. Third, the one or more trained ML models tend to learn how the user performs edits for a particular section. Although the one or more trained ML models do not cross pollinate between different sections of a website, the system may enhance decision-making capabilities by learning an order or types of requests performed by the user to better leverage its prediction capability for tool selection and execution. As a result, the system may produce one or more instructions for executing against the particular section that maintains continuity from previous sections and fulfills the desired request.

In some implementations, the system may output a selection of one or more web development tools for executing the set of instructions. For instance, the system may provide a set of potential web development tools to the system for the one or more trained ML models to select from for responding to the user request. The system may analyze the inputs, including the set of web development tools, the scoped request history for the section of the webpage being analyzed, and any other pertinent information related to the request to select one or more web development tools from the set of web development tools to be selected. These selected web development tools, which may be application programmable interface (API) tools, for example, enable the system to execute the programmed instructions additionally output by the one or more trained ML models. As a result, the system may execute a set of instructions using the one or more selected web development tools in a specified order to generate updated graphical user interface (GUI) data for responding to the user query. The system may provide the updated GUI data to the client device of the user, where the client device may render the updated GUI data in place of the requested portions being modified or created.

The ML techniques described herein are provided within a Web Experience Platform (WEP) technique in order to improve various aspects of web development, such as automatic page generation, component refactoring, localization, and performance tuning within a comprehensive website development platform, such as the WEP. In the WEP, machine learning models, e.g., large language models (LLMs), large action models (LAMs), may be trained and/or prompted using extensive datasets including versioned design snapshots, CMS collection content, component code libraries, build artifacts, and historical performance metrics. This data is leveraged during live authoring and runtime management sessions to generate new layout structures, translate content into additional languages, rewrite copy to meet accessibility guidelines, recommend edge caching strategies, and adjust build configurations for faster load times. By using these insights, the ML models enhance the experience of site controllers who design and maintain websites and of site users who access published pages. The integration of such ML models within the WEP also streamline backend operations by triggering incremental builds, updating database records, applying schema validations, and scheduling targeted cache invalidations without manual intervention. In this way, the incorporation of ML models improves not only the user experience delivered by the WEP, but also optimizes the underlying technical infrastructure that stores data, compiles builds, and serves content across the WEP.

The systems and techniques disclosed herein leverage ML to improve website development with varying levels of process automation. For example, a site controller may type a natural language request asking for a five-page marketing microsite, and a LLM may generate the corresponding page structures, themed style tokens, component markup, and placeholder media. The build pipeline then compiles these assets, writes them to the artifact repository, and publishes them through the edge delivery layer without the controller writing any code. As another example, when a site controller requests a redesigned testimonial slider, a ML model may query a content database to understand existing collection fields and reference links and then generates an updated component that preserves field binding relationships. The build system validates the generated markup against the CMS schema, updates only the affected bundle, and deploys the component so the new slider renders correctly across all locales without breaking any data driven pages.

In one general aspect, a method is performed by a server. The method includes: receiving, by a server system and from a computing device, request data specifying a natural language description of a webpage modification; determining, by the server system and based at least on the natural language description, one or more web development tasks corresponding to the webpage modification; determining, by the server system, one or more web development tools configured to execute the one or more web development tasks; generating, by the server system, prompt data for one or more trained machine learning (ML) models, where the prompt data includes one or more instructions for generating a code update segment for the webpage modification based on execution of the one or more web development tasks by the one or more web development tools; obtaining, by the server system and from the one or more trained ML models, output data for the code update segment, wherein the code update segment causes the one or more web development tools to execute the one or more web development tasks; generating, by the server system and based on the output data, a deployment artifact by executing the code update segment; and providing, by the server system and to the computing device, an instruction that, when received by the computing device, causes the computing device to display a representation of a modified webpage based on the deployment artifact.

Other implementations of this and other aspects of the disclosure include corresponding systems, apparatus, and computer programs, configured to perform the actions of the methods, encoded on computer storage devices. A system of one or more computers may be so configured by virtue of software, firmware, hardware, or a combination of them installed on the system that in operation cause the system to perform the actions. One or more computer programs may be so configured by virtue having instructions that, when executed by data processing apparatus, cause the apparatus to perform the actions.

The foregoing and other implementations may each optionally include one or more of the following features, alone or in combination. For example, some implementations include all the following features in combination.

In some implementations, the one or more web development tools include at least one of a style modification tool, a content update tool, a grid layout tool, or an HTML structure modification tool.

In some implementations, the method further includes obtaining, by the server system, user history data specifying a set of webpage modifications previously submitted by a user associated with the computing device. In such implementations, determining the one or more web development tasks corresponding to the webpage modification includes identifying a particular set of web development tasks associated with the set of webpage modifications previously submitted by the user, and selecting a subset of web development tasks based on the particular set of web development tasks.

In some implementations, determining the one or more web development tools configured to execute the one or more web development tasks includes: identifying a particular set of web development tools associated with the set of webpage modifications previously submitted by the user; and selecting a subset of web development tools based on the particular set of web development tools.

In some implementations, the webpage modification includes at least one of a change to a background color of the webpage, a change to a style of the webpage, a change to a layout structure of the webpage, or a summary of content currently presented on the webpage.

In some implementations, determining the one or more web development tasks further includes: extracting, by the server system and from the request data, data identifying a section of a webpage associated with the webpage modification; retrieving, by the server system, a current state of the identified section of the webpage; and determining the one or more web development tasks based on the current state of the identified section.

In some implementations, the method includes: determining the one or more web development tools configured to execute the one or more web development tasks includes: generating a semantic index based on the natural language description of the webpage modification; identifying a set of application programming interface (API) tools specified in a content management system; and selecting a subset of API tools from among the set of API tools based on the semantic index.

In some implementations, generating the deployment artifact by executing the code update segment includes: executing each web development tool included in the one or more web development tools; obtaining tool output data based on executing each web development tool included in the one or more web development tools, where the tool output data combines respective tool outputs associated with each of the one or more web development tools; generating content modification data based on the tool output data; and formatting the content modification data to generate the deployment artifact.

In some implementations, the deployment artifact specifies at least one of a text segment for modified content of the webpage, one or more graphical user interface (GUI) elements for modified content of the webpage, or metadata that describes modified content of the webpage.

In some implementations, the representation of the modified webpage includes a difference view that identifies one or more edits between a current state of the webpage and the content modification.

The details of one or more implementations of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 illustrates an example of a technique for webpage modification using machine learning.

FIG. 2 illustrates an example of a web experience platform (WEP) for enabling web development using one or more ML models.

FIG. 3 is a block diagram of another example technique for webpage modification using machine learning.

FIG. 4 is a block diagram of a user interface that illustrates a chatbot for rendering webpage modifications.

FIG. 5 is a flow chart illustrating an exemplary process of modifying a webpage using machine learning.

In the drawings, like reference numbers represent corresponding parts throughout.

### DETAILED DESCRIPTION

This disclosure describes systems and methods for automating webpage modifications within a web development platform by generating constrained, task-specific prompts for machine learning (ML) models. In response to receiving request data specifying a natural language description of a webpage modification, a server system automatically determines one or more web development tasks corresponding to the modification. The server system further determines one or more web development tools configured to execute these tasks, where the tools are uniquely associated with an underlying CMS that supports the platform. The system then generates structured prompt data for an ML model, where the prompt includes instructions for generating a code update segment that are constrained by the specific schema, content, structure, and formatting requirements of the CMS. This structured approach ensures that any ML-generated code may be reliably executed to generate a deployment artifact, minimizing risks of inconsistencies with code already deployed in production and enabling users to implement complex modifications without specialized coding expertise.

This disclosed systems and techniques improve various aspects of webpage development, such as creating and modifying webpage content directly within a website environment using ML. In some implementations, the systems described herein enable users to modify content within a webpage that involves ML. Generally, the user may interact with a software application on their client device that allows users to create, publish, and modify digital content without any coding experience. Users may interact with this software application manage websites, manage website content, and generate new website content regardless of technical expertise or skill level. The software application may provide a graphical user interface (GUI) on the client device that enables the user to create, edit, modify, and publish webpage content online.

The techniques described herein also improve upon contextual guidance provided by code generation systems. For instance, instead of merely retrieving information from a fixed knowledge base to guide a user's manual actions, the present disclosure describes a system that automates the execution of webpage modifications. While some code generation systems utilize a passive knowledge base for informational retrieval, the disclosed systems leverage the CMS as an active, executable framework. This is achieved by constructing a prompt for an ML model that is specifically constrained by a set of web development tools and tasks that are native to the CMS. The system's awareness of the available tools, their development history, prior usage patterns, and the multi-tenant architecture of the platform allows it to generate a highly specific set of instructions for the ML model, moving beyond informational guidance to automated action.

The systems and techniques also leverage prompt construction techniques distinct from some code-generation platforms or “design-to-code” platforms, which typically generate code artifacts (e.g., HTML, CSS) in a relatively unconstrained context. Such platforms often lack deep awareness of the complex rules, schema, and historical context of a specific, pre-existing production environment, such as a multi-tenant CMS. In contrast, the prompt construction processes described herein are uniquely informed by a confluence of data sources. This includes the user's current visual context (e.g., a portion of the webpage the user is viewing and interacting with) and the current, pre-modification state and configuration of the specific webpage. The data sources also include the architectural and historical constraints of the underlying CMS, including the specific web development tools and tasks available to a particular user account and compatible with the target webpage. This multi-contextual awareness enables a high degree of automation within a complex environment, ensuring that the ML-generated code update segment is not only responsive to the user's natural language request but is also guaranteed to be compatible, executable, and consistent with the production environment, thereby avoiding the risks associated with deploying code generated in an isolated context.

In some implementations, the system may generate website content using the ML model in response to a request provided by a user. For example, a user may interact with a particular portion or section on a webpage of a website through a client device. The section may correspond to a specified region of the webpage, e.g., a header, a footer, a text box, a column section, a row section, a blocked section, or another specific section. The user may desire to perform one or more web development tasks. A web development task may correspond to a task to be performed on a webpage. The web development task may include, for example, modifying a particular portion of the webpage, change content displayed on the webpage, update formatting of one or more sections of the webpage, change color schemes, change layout, or change schemes shown on the webpage, to name a few examples. For example, the user may request the system change a background color of a particular section of the webpage. The client device may provide data identifying the particular section of the webpage, the user request, and device attributes to the server to generate responses to the user request. Accordingly, the system may generate and replace the color section within the website environment, using the ML and rendering new GUI data with the appropriate color section, all without the user having to access the user model or write code that performs a specific function related to the user's request, and preserving the user's creative flow process. Other web development tasks are also possible.

Some approaches to webpage modification typically require authors to write code or learn the use of a web development tool to generate webpage content. In this case, an author may by viewing a particular webpage. If the author desires to use a web development tool, such as an API, that interacts with a ML model or interacts with another tool as part of the webpage creation, the author opens a shell to write code to execute performing the function. In this case, the author would open the shell or a coding script that would require the author to write, debug, and execute software for performing the particular function. However, this process of writing software during webpage develop creates many technical challenges. For one, the author needs to understand the formatting, context, and rules of the particular software that is accepted by the website environment. This may be a challenge if the author does not understand how to write software or understands some software, but not the requisite software language needed to perform the desired task.

In another example, a user having to write software may interrupt the author's flow of website creation. In some examples, the output of the software may need to be tweaked and further refined to match to the already created webpage, and lack the desired field structure, length, data type constraints, or webpage scheme. As a result, the author may need to manually adjust the software to produce the desired output, which may result in further delay, lead to loss in accuracy of data, and removal of specific components from the output that fit within the constraints of the webpage. These issues may be compounded by a machine learning model's hallucinations and error prone debuggers that lack the ability to manually adapt to a user's query. These issues may exacerbate the user's webpage modification process and may leave the user's experience frustrated.

The techniques described in this specification improve upon the manual creation of software for modifying a particular portion of a website by performing an automated process with one or more trained ML models within an overall ecosystem of the website authoring environment. In particular, the system may receive a request from the user to perform a particular action and may construct a prompt to submit to the system for causing the one or more trained ML models to output various data types. The system constructs the prompt using data that identifies, for example, message history according to a section that is to be modified, a set of potential web development tools for executing the user query, the user query itself, and the existing GUI content of the section to be modified. The system may submit prompt data to the one or more trained ML models, which produces various outputs.

The system also receives the various types of outputs from one or more trained ML models over a network. Examples of these outputs include one or more selected web development tools from the set of potential web development tools, instructions for executing each web development tool, and an order for web development tool execution. The system may validate each of these outputs to ensure that the one or more trained ML models did not hallucinate, provide artifacts, or otherwise fabricate output data. Once the system validates each of these outputs, the system renders the output by executing each web development tool in the order specified by the one or more trained ML models. The system may generate the rendered output in the form of GUI data, and transmit the GUI data to the client device. The client device may receive the GUI data, and apply the GUI data as rendered updates to the section corresponding to the user query. As a result, the system provides one or more technological improvements. For example, the system reduces network round trips, reduces overall CPU processing by preventing the server from having to automatically perform a selection of which web development tools to execute, and reduces the number of iterations that need to be performed for responding to the user query. The system may generate responses that directly align with the user query and the system may use those responses to automatically update the client device of the user responsive to the user query, without the user having to perform an additional steps or processes.

In some implementations, website content is organized and structured by collections. A collection refers to a group of items organized for a particular purpose. The collection may be created, for example, to support a webpage, such as a blogpost, an event, a social media page, or other. Each collection provides one or more items that share a common schema. The one or more items may include, for example, data fields, data types, formats, required fields, disallowed fields, constants, and other data components. The fields may include text boxes such long or short texts, numbers, dates and times, images, assets, videos, references to other collections or other items, and one or more unspecified data fields. Generally, and as will be described below, when an author creates a webpage, the author may collect a collection that supports a webpage, or a series of collections that supports multiple webpages of a website.

Generally, the system herein enables a designer or author to interact with a particular section within the webpage on a client device. The designer or author may select a particular section to be modified and submit a query through a GUI window, e.g., a chatbot, that specifies an edit to be made to that particular section. The edit may include, for example, to resize a GUI block to fit within a portion of that particular section. The data is provided to the server, which works with the ML model to generate a set of web development tools and instructions for executing the set of web development tools that conform to the user request. The server may present the output to the client device, updating a currently displayed GUI with the output that matches to the content of the user request.

The automated generation of webpage modifications is based on a curated set of web development tools and their corresponding tasks, which are managed through an CMS. This ensures that any generated code is compatible with platform architecture and accurately reflects up-to-date features and capabilities without requiring manual intervention. For instance, when the system receives a natural language description of a desired webpage modification, it determines the specific web development tasks required and identifies the corresponding web development tools from the CMS-managed set. At runtime, the system constructs a constrained prompt that includes the identified tasks and tools, along with the user's request and the current state of the webpage section, for one or more ML models. The resulting model output is a structured code update segment that, when executed, generates a valid deployment artifact aligned with the platform's technical requirements.

Further, the code generation techniques disclosed herein are directed to improvements to problems that uniquely arise in computer-related technology. As described herein, the techniques improve how a networked computing system translates high-level, abstract user requests into reliable, executable code under strict compatibility and performance constraints. This operates on machine-generated signals (e.g., a structured list of available web development tools, historical context from a specific webpage section, schema constraints from the underlying CMS) and applies computer-implemented processes (e.g., natural language processing to map requests to tasks, tool selection based on CMS compatibility, constrained prompt assembly) that condition ML models on the platform's specific architecture. These steps change the functioning of the computer by reducing the generation of non-functional or “hallucinated” code, enforcing architectural consistency via the CMS-managed toolset, and decreasing the computational resources required to produce a valid deployment artifact. Manual analogs of these operations result in a fundamentally different process.

For instance, a person cannot, within an interactive timeframe, analyze a natural language request, cross-reference it against a dynamic library of hundreds of proprietary API tools, determine the optimal sequence of tool execution, and generate a syntactically correct code segment that respects the hidden schema of a complex CMS. The operations involved in the disclosed code generation techniques therefore address problems unique to computer-automated software development (e.g., ambiguity of natural language, API compatibility, state management, and architectural drift) and constitute a specific improvement in the operation of the computing system.

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. ML models may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a machine learning system. Examples of models include machine learning models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As described herein, a “tool” refers to a discrete, callable unit of functionality that is registered within a platform registry and made accessible to one or more subsystems of an application. A tool may encapsulate a particular software capability, module, or feature, and may be invoked directly by a user or indirectly by an orchestration engine, assistant subsystem, or agentic process. A tool may be defined by a metadata specification that describes its functional purpose, input parameters, output types, and access constraints. Such metadata may further include contextual invocation rules or skill-gating requirements that limit tool execution based on user roles, system state, or external conditions. A tool may also be executed within the host application or may trigger remote services, APIs, or external modules. For example, a tool may perform a data transformation, retrieve content from a content management system, initiate a machine learning inference, or apply an automation feature to a digital asset. Tools may be atomic (e.g., performing a single function) or composite (e.g., orchestrating multiple underlying functions).

For example, a web development tool generally refers to a tool that performs a function or functions for performing an action related to a webpage. The web development tool may be used to perform a task related to the webpage, such as any action requested for by a user or automatically determined by the system. The web development tool may perform the task that updates content shown on webpage in accordance with the task being performed. In some examples, such web development tools include editors that allow direct modification of webpage text, images, or layout. Other examples include automation tools that rebuild or reload assets when underlying code changes. In some other examples, such tools include interfaces that enable insertion of interactive components such as forms, widgets, or chat interfaces. Other examples include testing and optimization tools that dynamically vary webpage content for different users, and low-code or design-to-code platforms that generate webpage structures or elements automatically from higher-level inputs.

As described herein, a “module” generally refers to a discrete, encapsulated software unit that implements a defined subset of functionality within a larger system. For example, a module may include executable code, data structures, and associated interfaces that collectively enable the module to perform one or more tasks, operations, or services. In some implementations, a module may expose an API or inter-process communication interfaces through which other system components (e.g., agents, tools, or orchestration engines) may invoke module functionality. The module may be configured for local execution within an application runtime or for remote execution via a distributed service environment.

As described herein, a “collection” generally refers to a structured data container defined within a content management system. A collection may include one or more fields specifying attribute types and constraints, where each field is configured to store content of a designated type (e.g., text, image, reference, or relational identifier). The collection may further define a schema for a class of content items and may be programmatically bound to presentation templates for automatic instantiation of one or more web pages or components.

As described herein, a “component” generally refers to a reusable design element or grouping of design elements within a visual design environment. A component may include structural markup (e.g., containers, text elements, media placeholders), style definitions (e.g., Cascading Style Sheets (CSS) class associations), and behavioral attributes (e.g., event listeners, animations). Components may be instantiated multiple times across different pages, with instances linked to a common definition such that modifications to the component definition propagate to each instance.

As described herein, a “schema” generally refers to a structured definition that specifies the organization, attributes, and relationships of data within a system. A schema may define one or more fields, each field associated with a data type (e.g., text, integer, media, or relational reference), a set of constraints (e.g., required, optional, uniqueness), and optionally a linkage to other schemas or data sources. The schema operates as a blueprint governing how data is stored, validated, and retrieved by the system. A schema may be represented in a machine-readable format (e.g., JavaScript Object Notation (JSON), Hypertext Transfer Protocol (XML), proprietary markup), enabling programmatic generation of data containers and enforcement of structural consistency across instances. At runtime, the system may validate input data against the schema to ensure compliance and may utilize the schema to automatically bind data values to.

As used herein, a “template” generally refers to a parameterized layout structure defining a presentation format for one or more data-driven pages. A template includes a set of design elements, placeholders, and binding definitions linking fields of a collection to corresponding elements of the layout. Upon execution of a publishing or rendering process, the template is programmatically combined with data from one or more collection items to generate fully populated output pages or views.

As used herein, “interactions” generally refer to declarative animation and behavior specifications that define dynamic changes to one or more elements of a rendered page in response to runtime events. An interaction may include a trigger definition identifying the initiating event, a set of target elements, and one or more animation or state-change operations to be applied to the target elements according to defined timing or sequencing parameters.

As used herein, a “trigger” generally refers to an event condition that initiates execution of an associated interaction or workflow. Triggers may include user-interface events (e.g., click, hover, scroll, page load) or system-generated events (e.g., content update, data submission). A trigger definition may specify the scope of the monitored condition and, upon detection of such condition, causes initiation of the corresponding action sequence.

As used herein, “logic” refers to a declarative workflow specification defining automated operations to be executed in response to system or user events. Logic may be represented as a sequence of interconnected nodes or steps, where each step specifies an action (e.g., data manipulation, API request, content update) and may include conditional branching, variable mapping, or external service integration. Logic is evaluated and executed by a backend workflow engine in response to event detection.

As described herein, an “agent” (or “ML agent”) generally refers to a software entity configured to operate autonomously or semi-autonomously within a computing environment by perceiving context, evaluating state, and executing one or more actions on behalf of a user or system. Agents may incorporate ML models (LLMs, LAMs), or other ML-based subsystems that enable adaptive behavior, natural language processing, decision-making, and dynamic invocation of system functionality.

Further, an “agentic” process or behavior generally refers to the autonomous or context-driven execution of actions by an agent, without requiring explicit step-by-step instructions from a user. For example, agentic functionality may include interpreting natural language or multimodal prompts based on processing input queries submitted by a user. In other examples, agentic functionality includes determining relevant goals or sub-tasks, invoking software capabilities (e.g., tools, functions, external services registered) within a platform registry, and sequencing or chaining such invocations until an objective is satisfied.

As discussed in detail below, the machine learning techniques disclosed herein may be provided to augment, streamline, and/or improve various aspects of a web experience platform that allows users to perform various types of actions relating to website development (e.g., access, design, develop, build, access, manage, analyze, modify, and edit). Through the use of machine learning, the techniques disclosed herein may allow users to modify website or webpage content without having to write software or perform additional functions for performing that modification. For example, in a ML-enabled web experience platform, when a user requests for changes or modification to components of a webpage, the machine learning may be configured to create new text, images, and other relevant content based on the user text, prompt, message history for that section to be modified, or other input provided by the client device.

Implementations of the present disclosure are described in further detail herein with reference to the creation of content for webpages. In some implementations, the techniques described in this present disclosure are applicable to the modification of content for other applications, such as applications, emails, product designs, brochures, or other products, to name some examples.

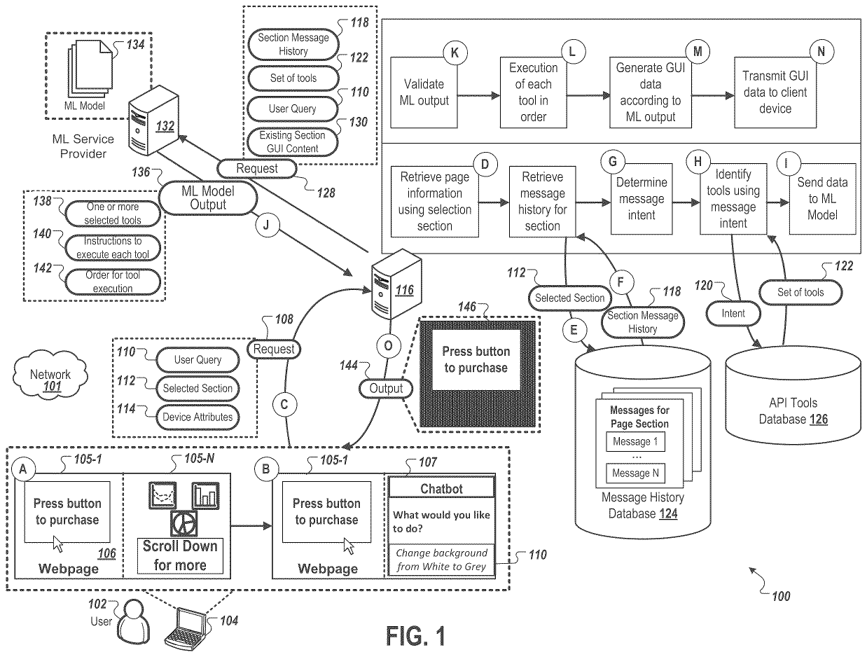

FIG. 1 illustrates an example system 100 that performs techniques for webpage modification using machine learning. The system 100 may include one or more servers or computers connected locally or over a network. The system 100 may include a network 101 that may be, for example, a local network, a Wi-Fi network, an intranet, an internet connection, or some other connection that enables the system 100 to communicate, e.g., transmit and receive, with various databases and one or more external devices. In some cases, the system 100 may include one or more databases. In some implementations, the system 100 may be performed by a cloud computing system over a network.

FIG. 1 illustrates various operations in stages (A) through (O), which may be performed in the sequence indicated or in another sequence. For instance, some of the stages may be performed concurrently, in part or in whole, may be skipped, or may be performed in different orders, e.g., stage (A) may be performed after stage (B).

As illustrated in system 100, a user 102 may seek to modify one or more sections of a webpage using a client device 104. The user 102 may be, for example, a developer of a webpage seeking to access a webpage, a user seeking to access information from the webpage, and an administrator seeking to validate a configuration of the webpage. The user 102 may communicate with the system 100 through their respective client device 104. The client device 104 may include a personal computer, a workstation, a handheld device, a portable table, a smart phone, or any other type of device capable of communicating over a network to the server 116. The client device 104 may communicate with the server 116 over the network 101 using any form of communication protocol, e.g., Hypertext Transfer Protocol (HTTP) or Transport Layer Security (TLS). Other examples are also possible.

In some examples, the client device 104 may execute a web-based application or a native application that provides an interactive interface to the user 102. In some examples, the client device 104 may communicate with the server 116 over a network 101 through one or more application programmable interfaces (APIs), for example, to request webpages, retrieve configuration information, retrieve section information for various websites, modify sections of webpages, or perform other requests. The one or more APIs may enable a single webpage interaction or enable multiple, bulk, or batched webpage requests. In some cases, the one or more APIs enable streaming of data between the client device 104 and the server 116 for real time or incremental GUI updates to the particular webpage.

During stage (A), the client device 104 may present a GUI that enables the user 102 to access particular webpage, such as webpage 106. The GUI enables the user 102 to perform an action on a particular section or sections of the webpage 106 and transmits a request 108 to the server 116 for performing the action. For example, the request 108 may specify one or more web development tasks to perform on a section of the webpage, such as changing a color of the section of the webpage 106. As illustrated in the example of FIG. 1, webpage 106 may be composed of different sections 105-1 through 105-N (hereinafter “sections 105”). Each section specifies a portion of the webpage and displays one or more features relevant to that portion of the webpage. For example, section 105-1 is related to GUI data for “Pressing button to purchase”. Section 105-N is related to GUI data showing different graphical types and indicates to the user to scroll down for more content. Each section may include other information. Each section may be divided according, for example, a column of the webpage, a row of the webpage, a portion of the webpage divided off from other portions, boxed-in or region areas that are separate from other portions of the displayed webpage, and may include other dividers.

The user 102 may select or indicate a web development task to perform on a section of the webpage 106 during modification of the webpage 106. These web development tasks may include, for example, changing a color scheme of that scheme, changing a layout, moving an element within that section, modifying a portion of the text, changing tone, translating to another language, or creating GUI data to include within that section, to name a few examples. In some examples, the user 102 may specify a webpage by providing a uniform resource locator (URL) for the webpage or website that includes one or more webpages. In response to accessing the website, the user 102 may desire to interact with one or more sections 105 of that webpage to perform the web development tasks within those sections.

In the example of FIG. 1, the user 102 may select the section 105-1, as indicated by the mouse element shown over the “Press button to purchase”. The user 102 may select the section 105-1 by clicking within that section, highlighting that section, tapping on the display of the client device 104 with a user's finger, or otherwise indicating that section 105-1 is the interested section for the user 102. In response, the webpage application execution on the client device 104 transitions webpage 106 to a chatbot environment, as shown by the chatbot interface 107.

During stage (B), the client device 104 displays a chatbot interface 107 overlaid on the webpage 106. In some implementations, the client device 104 may present the chatbot interface 107 over one or more sections of the webpage 106 that the user 102 did not select. In some implementations, the client device 104 may present the chatbot interface 107 adjacent to each of the sections of the webpage 106 so as to preserve visibility of the contents of the webpage 106. In some implementations, the client device 104 may present the chatbot interface 107 on another window, allowing the user 102 to easily switch windows between the chatbot interface 107 and the webpage 106.

The user 102 may submit text to the chatbot interface 107 for performing an action related to the selected section 105-1 of the webpage 106. The chatbot interface 107 may present a question to the user, such as “What would you like to do?” or “Please describe the modification to the selected section.” In the bottom of the chatbot interface 107, the user 102 may submit the desired modification in natural language. The desired modification may be an audio message or a text message indicating the change the user 102 would like to make to the selected section 105-1. As illustrated in the example of FIG. 1, the user 102 requests to “Change background from White to Grey.” Other examples are also possible, such as “Change Font Size to 14,” “Move the ‘Press Button to Purchase’ box to a smaller window,” or “Add graphical images surrounding the ‘Press Button to Purchase’ box,” to name a few examples. The client device 104 and the server 116 may rely on natural language processing techniques, for example, to interpret and process the user query 110 submitted by the user 102.

In some implementations, the system 100 provides technological advantages by scoping each chat interaction with user 102 to a particular section of the webpage 106. For example, the section scoped conversations may reduce the size of the message history that is ultimately transmitted to the ML service provider 132, ultimately lowering computational processing. Further, by limiting the section with which the chats are scoped, the system 100 constrains web development tasks to be performed to those elements within the section 105-1, preventing any unintended edits to other portions of the webpage 106. This isolation minimizes risk of cross section edits and improves the processing for modifications applied to a given section.

The client device 104 may generate the request 108 according to the user query 110 submitted by the user 102. The request 108 may include, for example, the user query 110, the selected section 112, and the device attributes 114. In some cases, the request 108 may include other data, such as attributes of user 102, and timestamp information. In some cases, the user query 110 may include a representation of the GUI data that was interacted with on a particular section, e.g., section 105-1, on the webpage 106. The representation of the GUI data may include, for example, Hypertext Transfer Protocol (HTTP) data, rich text, imagery, or other information. The representation of the GUI data may also include locational information corresponding to the data being modified on the section 105-1 of the webpage 106, such as pixel locations or other information.

In some cases, the request 108 may include webpage attributes. The webpage attributes may include, for example, an identifier associated with the selected section 105-1, an identifier associated with the webpage 106, and an identifier associated with a particular element of section 105-1 being modified, to name some examples. The identifiers may represent the structural information of the section of the webpage 106 that enable the server 116 to identify this information in the corresponding database for processing, e.g., submitting to one or more trained ML models.

In some cases, the request 108 may include user attributes. The user attributes may include information that represents the user 102 communicating with the server 116 through the client device 104. The user attributes may include, for example, a user identifier, geolocational data of the user 102, username and password of the user 102 for authenticating with the server 116, and other information that identifies the user 102.

In some cases, the request 108 may include device attributes 114. The device attributes 114 may include, for example, an internet protocol (IP) address of the client device 104, a media access control (MAC) address of the client device 104, network characteristics utilized by the client device 104, operating system of the client device 104, browser used on the client device 104, and communication protocols used by the client device 104, to name some examples.

In some implementations, the request 108 may include information that identifies one or more other sections of the webpage 106. This may include, for example, the sections 105-2 through 105-N, in addition to the selected section 105-1. The server 116 may use the non-selected sections to further identify the webpage content in the database. In some cases, the request 108 may include metadata that describes the webpage 106, the selected section 105-1, and the non-selected section 105-2 through 105-N. In some cases, the user 102 may select multiple sections, and specify through the user query 110 an action that is performed to each section of the multiple sections.

In some implementations, the user query 110 may specify the web development tasks, e.g., action, operation, or operations to be performed on the selected section 105-1 of the webpage 106. The user query 110 may specify, for example, a color change, a move operation, an addition of text, a layout change, generate imagery, or another type of change. In some cases, the user query 110 may specify multiple web development tasks, and an order of each web development task of the multiple tasks. For example, the user query 110 may specify “First, change the background element color to blue. Second, move the blue background element to the upper left corner. Third, move the foreground element to the bottom right corner.” Other examples are also possible.

During stage (C), the client device 104 may transmit the request 108 over the network 101 to the server 116. The server 116 may receive the request 108 over the network 101. In response to receiving the request 108, the server 116 may initiate the processes of analyzing the text to determine the webpage where the requested web development task is being performed, the one or more sections for performing the requested web development task, and an intent of the user query or natural language description of the user query 110 that corresponds to the requested web development task, among other processes. In some implementations, the server 116 may queue the request 108 for processing in a distributed task manager that allocates webpage modification tasks. The server 116 may perform webpage modification tasks for a variety of client devices. As a result, the server 116 may validate the request 108 to determine that the request 108 was submitted in the proper format, with the proper parameters, and that the data included in the request 108 matches to an expected schema.

In some implementations, the server 116 may receive the request 108 and parse the received request 108 to determine its contents. Specifically, the server 116 may extract the user query 110, the selected section 112, and the device attributes 114. In some cases, the server 116 may extract the user attributes, the webpage attributes, and other information included in the request 108. In some cases, the server 116 may perform additional verification checks to standardize the data included in the received request 108. The server 116 may generate a record according to the received request 108 and store the record in memory with a time stamp. For example, the server 116 may recognize from the received request 108 the user query 110 and the selected section 112 for where the requested action described in the user query 110 is to be performed. In some examples, the server 116 may recognize whether the request 108 transmitted was authorized by analyzing the user attributes and the device attributes 114, accordingly. If the server 116 determines that any information is missing from the received request 108, that should otherwise be available, then the server 116 may fill in the missing information using default information, and logs the missing information with the record in memory. In some cases, the server 116 may deny the request if a sufficient amount of information is missing or incorrect.

During stage (D), the server 116 may retrieve webpage information corresponding to the webpage 106 displayed on the client device 104 using data extracted from the request 108. In particular, the server 116 extracts the various information from the request 108. The various information including, for example, the selected section 112 and the webpage attributes, allows the server 116 to resolve and/or identify the information used to render the webpage 106 on the client device 104. The webpage 106, as designed by the user or in the process of being designed by the user 102, is bound to the constraints, rules, or limitations defined by the one or more sections, GUI data for those sections, and an overall configuration of the sections as they fit within the entirety of the webpage.

Using the extracted selected section 112 information, the server 116 may identify a corresponding section of the webpage 106 that is currently displayed on the webpage 106. If the extracted selected section 112 information is missing from the request 108, then the server 116 may attempt to infer the section that is selected on the webpage 106 according to the information provided in the user query 110 or any metadata described about the webpage 106.

The server 116 may utilize the URL of the webpage 106 or the metadata to allow the server 116 to access the particular webpage. The server 116 may identify the section or sections of the webpage 106 that the user 102 has selected according to the data included in the selected section 112. In some examples, the server 116 may provide the URL of the webpage 106 and the selected section 112 to a database. The database may return data identifying the section of the webpage 106, e.g., section 105-1, a pointer of the data identifying the section of the webpage 106, or GUI data of the section 105-1 of the webpage 106. In some examples, the server 116 may access the selected section 105-1 by using the information in the selected section 112 as an index to the webpage 106. In this example, the server 116 may analyze metadata of the webpage 106 to identify the selected section 105-1, including its limits, constraints, and/or content, and retrieve the data associated with the selected section 105-1 from the webpage 106. The retrieved data associated with the selected section 105-1 is stored in memory with the record for the received request 108.

During stage (E), the server 116 may retrieve message history for the selected section 105-1 from a message history database 124. The message history for the selected section 105-1 may include one or more web development tasks previously performed for that section of the webpage 106. The message history may include, for example, previous requests transmitted by one or more other users and include similar information as request 108 for performing actions on a particular section of a webpage, data that identifies web development tasks performed by the server 116 related to the particular section of the webpage, data submitted to a machine learning service provider 132 related to the web development tasks, data output from the machine learning service provider 132 in response to processing the submitted data, data associated with the web development tasks related to the particular section of the webpage, and other metadata describing the relevant web development tasks performed. The message history is stored and tracked over time to ensure the machine learning model maintains a structural and/or content similarity across edits, as will be further described below.

In some implementations, the message history database 124 may include a group of webpage sections that have been generated by various users and webpages that have interacted with the server 116. Each webpage entry in the message history database 124 may include a set of sections, and each section may include one or more messages that correspond to web development tasks or actions previously performed for that section. The webpage entry may include a key, such as a URL or other, that defines that webpage and another key that allows for accessing a particular section of the webpage. As such, the webpage entry may include a set of relationships that describe a webpage, one or more sections of that webpage, and one or more messages for each section of that webpage. In some cases, if a webpage has different versions, then the message history database 124 may store each version of that webpage, and corresponding sections and prior web development tasks for each section of the versioned webpage. As a result, the message history database 124 may track the web development tasks performed for each section of a webpage over time.

As illustrated in the example of FIG. 1, the server 116 may submit data that identifies the selected section 112 of the webpage 106. The data that identifies the selected section 112 of the webpage 106 may include, for example, a key identifier, a scrambled key, or another value that represents the section 105-1 of the webpage 106 to be modified. The data that identifies the selected section 112 of the webpage 106 may include a URL of the webpage 106 and metadata that describes the section 105-1 of the webpage 106, such as locational coordinates of the section 105-1 or constraints of the section 105-1 within the webpage 106.

During stage (F), the server 116 may identify the messages for the page section using the data that identifies the selected section 112 in the message history database 124. In some examples, the server 116 may utilize the data that identifies the selected section 112 as a key or index to identify a webpage and the selected section of the webpage that corresponds to the information in the selected section 112. Then, the server 116 may retrieve the prior messages, e.g., message 1 through message N, corresponding to the previous messages or actions performed on that selected section 105-1. For example, the server 116 may identify the section message history 118 for the section 105-1 of the webpage 106. As indicated above, the section message history 118 may indicate that section 105-1 previously received web development tasks related to, for example, changing a font color, changing a font size, changing a layout scheme, and adjusting the number of images shown in the section 105-1, to name some examples.

The server 116 may verify that the section message history 118 belongs to the section 105-1 of webpage 106 currently displayed on the client device 104. In some cases, the server 116 may retrieve the latest action performed in the section message history 118 to ensure its output matches with the latest GUI content shown on that section 105-1 of webpage 106. In some cases, the server 116 may recreate the GUI content for the section 105-1 of webpage 106 by executing each of the messages described in the section message history 118 to ensure the resultant output of each of those messages matches to the latest GUI content shown on the section 105-1 of webpage 106. If the server 116 determines that the latest GUI content shown on the section 105-1 of webpage 106 matches to the resultant output, then the server 116 deems the section message history 118 as accurate.

During stage (G), the server 116 may analyze the user query 110 extracted from the request 108 to determine its intent. In particular, the server 116 may apply one or more techniques, e.g., natural language processing techniques, to analyze the content of the user query 110 and determine the intent of the user query 110. In some cases, the server 116 may apply natural language processing techniques to analyze unstructured text data and extract actionable insights from the user query 110.

These techniques may include identifying syntactic structure and semantic meaning of the data within the user query 110, to aid downstream processing to perform tasks based on the determined intent of the user query 110. In some cases, the natural language processing techniques may use machine learning classifiers, neural networks, or other rule based systems to identify candidate intents and determine an intent from the candidate intents.

In some implementations, the server 116 may analyze the section message history 118 to augment the determination of the intent. For example, the server 116 may analyze the content of the user query 110 and the content of the one or more messages from the section message history 118 to determine the intent of the user query 110. The one or more messages from the section message history 118 includes previous determinations of intent for the same section of the webpage, e.g., section 105-1. As a result, the server 116 may apply these previous determinations of intent to the user query 110, and aid in determining the overall intent of the user query 110.

For example, as illustrated in FIG. 1, the server 116 may determine that the intent of the user query 110 corresponds to a modification action specifying that section 105-1 of webpage 106 is to be changed from a first background color, e.g., white, to a second background color, e.g., grey, as indicated by the following user query 110—“change background color from white to grey” for section 105-1 of webpage 106. In other examples, the server 116 may determine that the intent 120 of the user query 110 is to perform another action, such as a retrieval action, a navigation command, a GUI modification, or another type of modification. The server 116 may determine this meaning and structure as text, data identifiers, or other data representations of the user query 110 of the request 108.

Based on the determined intent 120 of the user query 110, during stage (H), the server 116 may identify a set of web development tools that are capable of performing one or more web development tasks associated with the determined message intent of the user query 110. In some implementations, the server 116 may utilize the determined intent 120 as an index into the application programming interface (API) tools database 126 or another database. In some cases, the server 116 may maintain a mapping between candidate intents from a user query and one or more editing or modification tools, e.g., web development tools. In response to the server 116 determining the intent 120 of the request 108, the server 116 may query or identify from the mapping the one or more editing or modification tools that are potentially capable of performing the actions associated with the determined intent 120 of the user query 110.

In some implementations, the API tools database 126 may store a set of web development tools, such as API tools, for performing web development tasks to sections of a webpage. The set of web development tools may include, for example, modifying a visual attribute of a webpage element, moving or resizing an attribute of a webpage element, changing a layout of one or more webpage elements within a section, a style modification of the webpage element, a structure modification of the webpage element, an introduction of a graphical element, summarizing content currently presented on a webpage, or a removal of a graphical element, to name a few examples. The API tools database 126 may store a mapping between intents of a message and one or more API tools. For example, if the server 116 determines that the intent 120 of the user query 110 corresponds to “change background color,” the server 116 may identify a style modification tool from the API tools database 126. The style modification tool may perform one or more web development tasks to update a particular sheet of the section of the webpage. In some examples, if the server 116 determines that the intent 120 of the user query 110 corresponds to resizing an image or resizing a graphical interface element, the server 116 may select an image resizing tool that may perform one or more web development tasks, such as altering a width, height, or other attributes of the GUI element within the section of the webpage.

In some implementations, the API tools database 126 may store data that maps intents related to layout modifications to web development tools that operate on structural or architectural designs of the webpage. For example, if the determined intent 120 corresponds to “move the GUI box to a new location” within the section of the webpage, then the server 116 may select a layout adjustment tool that modifies the position of a GUI container within the section of the webpage 106 to a desired location. Similarly, if the determined intent 120 corresponds to an “add button” within the section of the webpage, then the server 116 may select an insertion tool that introduces a new graphical element, with parameters that specify button size, button text, button position, and a hyperlink that executes in response to a button press. If the intent relates to a removal action, the server 116 may identify a removal tool from the web development tools database 126 that eliminates an element from the section of the webpage and cleans up the removal. In some cases, a complex task, such as removing a text within a button may be resolved by sequentially performing multiple tools. In this example, this may include an identification tool to identify the button followed by the removal tool to remove the text within the button. The API tools database 126 store that identifies each of these API tools and all the server 116 to access the functional calls for each of these tools.

In some cases, the server 116 may access a library of pre-built webpage sections that are stored within the API tools database 126. The API tools database 126 may include web development tools that are executed using these pre-built webpage sections. This allows the server 116 to quickly access one or more web development tool calls customizable from a pre-built webpage section without having to execute through the ML service provider 132, ultimately improving processing speed for updating section 105-1 of webpage 106.

As illustrated in system 100, the server 116 may provide the determined intent 120 to the API tools database 126. The API tools database 126 may return a set of web development tools 122 that correspond to the determined intent 120. For example, the API tools database 126 may return a set of web development tools 122 that include a removal tool, an insertion tool, a modification tool, and an identification tool, to name a few examples. The set of web development tools 122 may be returned as API definitions, which allow the server 116 to instantiate each tool of the set of web development tools 122 depending on an instruction output by the ML service provider 132.

During stage (I), the server 116 may generate a request 128 to provide to ML service provider 132. The request 128 may include one or more instructions for generating a code update segment for a webpage modification. The one or more instructions included in the request 128 may include, for example, the section message history 118 retrieved from the message history database 124, the set of web development tools 122 retrieved from the API tools database 126, the user query 110 retrieved from the request 108, and existing section GUI content 130. The existing GUI content 130 includes the currently displayed GUI content shown on the section 105-1 of the webpage 106. The existing GUI content 130 may include objects, positional information, metadata, and other data components that visually illustrate the objects shown on the section 105-1 of the webpage 106, prior to any changes rendered responsive to the user query 110.

In some implementations, the server 116 may translate an internal representation of the existing GUI content 130 into a format that is consumable by the ML server provider 132. For example, the server 116 may maintain a proprietary format of the existing GUI content 130. Prior to sending the existing GUI content 130 to the ML service provider 132, the server 116 may translate the proprietary format of the existing GUI content 130 to HTML, CSS, or another markup language that allows the ML service provider 132 to analyze, process, and produce results for this section.

In some implementations, the request 128 may include any parameters related to the performance of the request 128. The parameters may include, for example, a maximum number of web development tools for the ML service provider 132 to select, a maximum number of instructions to execute for each web development tool, and a number of candidate outputs. These outputs enable the server 116 to better identify an output from the ML service provider 132 that is more in line with the determined intent of the user query 110. This information may all be packaged into a request 128, and then the server 116 may prepare the model request 128 for transmission to the ML service provider 132.

The ML service provider 132 may be a server system or cloud computing platform that provides access to one or more ML models 134, such as large language models (LLMs). The server 116 and the ML service provider 132 may be implemented as separate systems or may be integrated in a single system. For example, the ML service provider 132 may be a third-party service or may be managed and operated by the same party as the server 116.

The model request 128 includes information to cause the ML model 134 to provide a narrative, e.g., description, explanation, interpretation, of the user query 110 to be performed on the existing section GUI content 130. This narrative may be in the form of a code update segment that provides code or software for updating or modifying a webpage based on execution of one or more web development tasks by one or more web development tools. The server 116 may provide the model request 128 to the ML service provider 132 over the network 101. The ML service provider 132 may provide access to one or more ML models 134, such as LLMs, to process the data included within the model request 128 and produce one or more corresponding outputs, as will be described below.

During stage (J), the ML service provider 132 receives the model request 128 and generates multiple outputs in response. The ML service provider 132 parse the model request 128 and extract the data from the request 128, e.g. extract the section message history 118, the set of web development tools 122, the user query 110, the existing section GUI content 130, and any generation parameters. The ML service provider 132 may provide the extracted data as input to one or more ML models 134. In response, one of the ML models 134 may generate the ML model output 134 that includes the multiple outputs, as requested. The ML model output 136 may include a selection of web development tools 138, instructions 140 for executing each web development tool of the selected tools 138, and an order 142 for tool execution.

In some implementations, the ML model 134 may process the data from the model request 128 to interpret the meaning, relationships, data types, and context of these input data types. Generally, an ML model 134, e.g., an LLM, seeks to interpret and generate a narrative, e.g., human readable text, by analyzing various patterns across vast amounts of data. The ML model 134 may generate a coherent and contextually appropriate narrative of the extracted data and responsive to the model request 128. In some cases, the ML model 134 may also provide human understandable summaries of the extracted data from the request 128. For example, the ML model 134 may generate a detailed summary, rewritten paragraph, a shorter summary, a translation into a designated language, a tone adjusted variation, and included encoded or decoded values for the appropriate files. In such examples, when the ML model 134 generates the multiple outputs, each output is distinct or distinguished from one another so as to be easily recognizable by the server 116.

The ML model 134 may generate an ML model output 136 that satisfies to the requirements specified in the request 128. The ML model output 136 may include output data for the code update segment for modification of the webpage on the client device 104. For example, the ML model output 136 may include a set of one or more web development tools 138 selected from the set of web development tools 122, a corresponding set of instructions 140 for executing each selected tool, and a specified execution order 142 indicating a sequence to which the set of one or more web development tools 138 are to be applied. By including these elements, the ML model output 136 enables the server 116 to perform one or more web development tasks determined by the user query 110 to modify the existing section GUI content 130.

For example, if the determined intent of the user query 110 is “change background from white to grey,” then the ML model output 136 may select a style modification tool as the selected web development tool 138 selected from the set of web development tools 122, include an instruction 140 such as “set background color:grey”, and set that instruction as a first operation to be performed as specified in the execution order 142. In another example, if the determined intent of the user query 110 is to “resize a button,” then the ML model output 136 may select a resizing tool as the selected web development tool 138 selected from the set of web development tools 122, include one or more instructions such as “set box size height: 200 pixels” and “set box size width: 150 pixels”, and perform the height box size setting as the first operation and perform the width box size setting as the second operation, as specified in the execution order 142. Other examples are also possible.

The ML service provider 132 may transmit the ML model output 136 to the server 116 over the network 101.

During stage (K), the server 116 may receive and validate the ML model output 136. The server 116 may analyze each output included within the ML model output 136 and perform various functions to ensure the ML model output 136 includes the necessary outputs to respond to the user query 110. In some examples, the server 116 may verify that the ML model output 136 conforms to the guidelines of schema for the particular section 105-1 of the webpage 106. This may include ensuring that the one or more selected web development tools 138 are in fact selected from the set of web development tools 122.

In some implementations, the server 116 may map the executions of these web development tools back from HTML to the proprietary language. This ensures compatibility between the ML service provider 132 processing and the underlying data structures used by the server 116 may work collectively.

Additionally, the server 116 may determine whether the instructions 140 to execute each tool and the order 142 for tool execution corresponds to the actual tools specified within the one or more selected web development tools 138. In some examples, the server 116 may perform sanitization to ensure that the ML model output 136 does not include inappropriate language, is constrained according to the data from the user query 110, and the language is human readable. In some examples, the server 116 may ensure that the ML model output 136 follows appropriate formatting protocols.

In some implementations, the server 116 may validate the ML model output 136 by executing the selected web development tools 138 using the instructions 140 and the order 142 of the tool execution. In particular, the server 116 may execute the selected web development tools 138 using the instructions 140 and in the order 142 using the existing section GUI content 130. The server 116 may render GUI content in place of the existing section GUI content 130 and determine whether the rendered GUI content matches to the determined intent 120 from the user query 110. The server 116 may verify that the rendered GUI content matches to the determined intent 120 from the user query 110 using, for example, a classifier, a neural network, or another model that performs this analysis. If the server 116 receives an indication, e.g., a statistical likelihood that satisfies a threshold value, from the model that rendered GUI content likely satisfies the determined intent 120 from the user 102, then the server 116 indicates that the ML output is validated.

Alternatively, the server 116 may reject the ML model output 136, and subsequently the request 108 if the ML model output 136 is empty or does not pass the validation. In this instance, the server 116 may generate a structured error response to provide to the client device 104 that identifies the particular failure or feature that failed. For example, the server 116 may generate the error that includes “Image Width Larger than Webpage Section,” or “Image Height Resized to Larger than Webpage Section,” to name some examples. In some cases, the server 116 may generate the structure error response if the ML model 134 hallucinated and/or produced an output that is not legible or understood by the server 116.

In some implementations, the server 116 may include one or more recommendations to provide to the user 102 through the chatbot interface 107 on retry. These recommendations may include, for example, instructions to recommend a change of a query in the chatbot interface 107, a different section of the webpage 106 to select, or a recommendation to change the functionality to another functionality, e.g., change from “White to Grey” to “White to Blue”, for example. If some but not all of the output fails the validation, such as only a few of the tools executed, then the server 116 may discard the instructions and/or tools that failed and the server 116 may include a notification to provide to user 102 through the chatbot interface 107 indicating which of the outputs failed and why those candidates failed. If none of the outputs in the ML model output 136 failed, then the server 116 may proceed to stage (L).

In some implementations, the chatbot interface 107 may include a global assistant mode in addition to section specific scoping. The global assistant mode allows for the server 116 to access data across multiple sections of a webpage, and even multiple sections of multiple webpages. This allows for the user to request a modification change that applies to each webpage of a website, for example, in order to be consistent across all sections of a website.

During stage (L), after successful validation of the ML model output 136, the server 116 may commit the ML model output 136 by executing each of the selected web development tools 138 using the corresponding instructions 140 in the specified order 142. Unlike the processes performed in the validation step of stage (K), which involve a test execution to confirm the output of the ML service provider 132, the processes and execution performed in stage (L) perform the actual modification of the existing section GUI content 130 on the webpage 106. Here, the server 116 generates a deployment artifact for the webpage modification by executing the code update segment.

In some implementations, the server 116 executes the selected web development tools 138 by invoking a compiler to generate the deployment artifact. In particular, the server 116 invokes the compiler that parses the instructions 140 and generates one or more executable calls to the selected web development tools 138 and their corresponding API definitions as described in the API tools database 126. For example, the compiler may translate the instruction of “set background-color:grey” into an API call that updates color scheme of a sheet shown on the section 105-1 of the webpage 106. The compiler may invoke the particular API definitions for each selected web development tools 138 in the specified order 142, to ensure that modifications to the existing section GUI content 130 are applied in the correct order and meeting the determined intent 120 of the user query 110. For example, the server 116 may apply the validated modifications, style changes, resizing, relocation, element additions or removals to the existing section GUI content 130 to create a persisted and updated webpage 106. This may be performed using the selected web development tools 138 as defined by their functional headings in the API tools database 126.

The deployment artifact represents results of performing the aforementioned functions using the selected web development tools 138. For instance, the server 116 may obtain output data from the output of each executed tool and generate content modification data using the tool output data. For example, the content modification data may include, for instance, a text segment for modified content of the webpage, one or more graphical user interface (GUI) elements for modified content of the webpage, or metadata that describes modified content of the webpage, to name a few examples. The content modification data may be formatted to be displayed on the webpage 106, as will be further described below.

During stage (M), the server 116 may generate GUI data corresponding to the execution of the selected web development tools 138. Namely, the server 116 may generate GUI data using the deployment artifact from the results of executing the selected web development tools 138. The GUI data corresponding to the updated webpage 106 may include, for example, updated attribute values for the updated output, such as color scheme changes or style changes, identifiers stored in metadata of the modified or added elements, e.g., page identifiers, element identifiers, and content identifiers, structural information defining the updated webpage 106, and content information related to the updated webpage 106. In some cases, the generated GUI data may further include a markup version that allows user 102 to view the differences between the original section 105-1 of the webpage 106 and the updated section 105-1 of the webpage 106.

In some implementations, the server 116 may include an evaluation framework to score the selected tool modifications 138 generated by the ML service provider 132. The evaluation framework may execute a set of predefined test prompts against the selected web development tools 138 and record the resulting outputs. The recorded outputs may be scored manually or automatically by one or more machine learning models. For example, the server 116 may execute a benchmark suite of tests using the selected web development tools 138, capture the output as modified GUI content, and then apply a separate classifier, for example, to generate automated scores. The server 116 may aggregate the scores into a scorecard that indicates an overall performance. In some cases, the scorecard may be updated automatically on each code change to ensure regressions are identified and improvements are tracked.

During stage (N), the server 116 may transmit the GUI data corresponding to the updated webpage 106 to the client device 104. For example, the transmitted GUI data may be transmitted as output 144, which may be a compact JSON data structure that causes the client device 104 to render the data on the section 105-1 within the webpage 106. In some cases, the user 102 may decide whether to cancel the rendered update on the section 105-1, canceled the rendered update on the section 105-1, or perform another option.

During stage (O), the client device 104 may receive and display the GUI data from the output 144 on the section 105-1 of the webpage 106. As illustrated in the example of system 100, the output 144 includes a rendered GUI update 146 that illustrates a grey background instead of a white background, matching to request of the user query 110. The GUI update 146 replaces the GUI content previously shown on the section 105-1.

The system may repeat the process discussed above for stages (A) through (O) each time user 102, client device 104, or server 116 triggers the creation of an action to be performed on a webpage of client device 104 or on any other client device that communicates with the server 116. Additionally, the process of stages (A) through (O) may be performed independently and in parallel to provide different webpage changes for each of multiple different client devices that each have their own webpages loaded and have their own webpage views displayed, with different text and different actions being performed on their respective text.

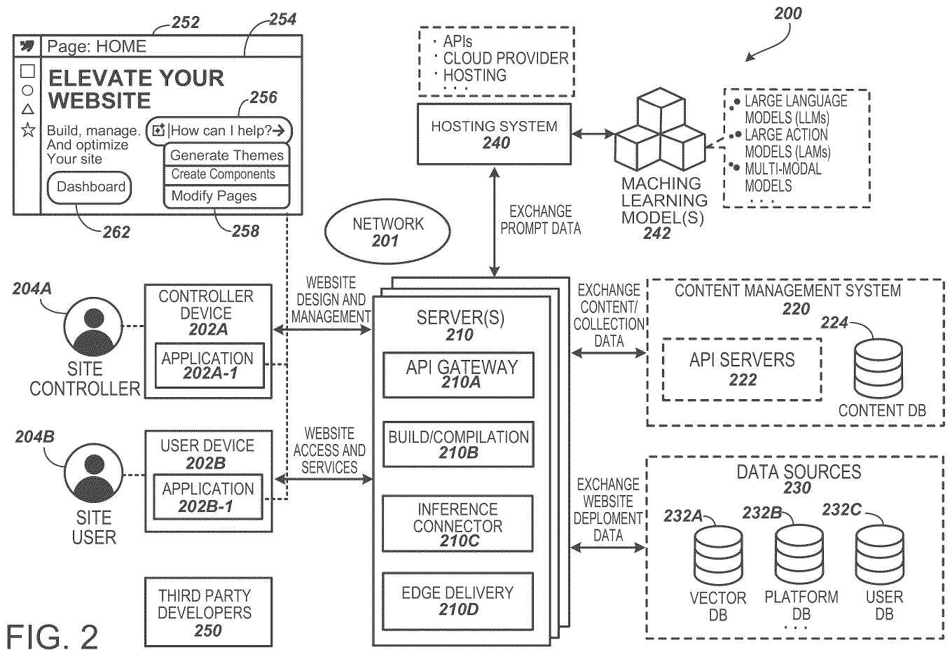

FIG. 2 illustrates an example of a web experience platform (WEP) 200 for enabling website development. In general, the website development capabilities enable users to design digital experiences, ingest user-defined digital experience specifications, transform the user-defined digital experience specifications into deployable artifacts, and distribute resulting web experiences over a network. For example, the WEP 200 may receive design-time input that specifies pages, components, styles, interactions, and content, compile or otherwise process that input (e.g., assistance from one or more ML models) into executable markup, code bundles, media, and metadata. The WEP 200 may store intermediate and final artifacts in multi-tenant data stores, identify published experience and associated application services to site visitors with edge-based delivery resources. This environment may further support content management, e-commerce, membership gating, localization, extension APIs, among other types of functionality.

In general, system 200 leverages ML within a content-management, schema-constrained WEP to address computer-centric problems in generating, selecting, and rendering webpage modifications at scale. System 200 obtains structured inputs defined by a content schema and associated metadata (e.g., section-level or hierarchy information), constructs constrained prompt data or model inputs from those structures, and applies trained ML models to produce candidate outputs that are validated for structural compatibility before use in the build and delivery pipeline. By grounding ML operations in machine-readable constraints and executing only schema-compatible results, system 200 improves computer operation in distributed web systems (e.g., by reducing integration failures, avoiding incompatible markup, limiting unnecessary network transfers, and enabling low-latency rendering of a single, selected variant on the client device). The WEP further augments and/or improves various aspects of the web development functionality through use of one or more ML models 242. These ML models 242 may be invoked at multiple, independent junctures of WEP workflows to streamline, accelerate, and/or augment tasks that have traditionally needed manual development effort.

For example, a site controller operating the controller device 202A may access an ML interface 256 (e.g., presented as a text-chat, voice, or multimodal panel within the existing design canvas) to submit natural language prompts that cause the one or more ML models 242 to generate entire page layouts, reusable components, helper functions, and the corresponding markup or code artefacts without leaving an authoring environment. After a site has been deployed, other ML interfaces may be used to request automated regeneration or modification of components in a manner that preserves data bindings and collection schemas maintained by a content management system (CMS) 220. This reduces the risk of breaking existing CMS-driven pages.

In another example, a site controller 204A or site user 204B administrator may invoke an ML assistant exposed through a dashboard widget to obtain step-by-step guidance on operational tasks (e.g., configuring localization variants, setting up gated-membership rules, or troubleshooting performance settings) based on conversational queries rather than navigating multiple configuration panels. Each of these interfaces may simply route prompt data to external model resources (e.g., hosting system 240) and returns model output to the same front-end context, the ML functionality may be layered onto different phases of the website-development lifecycle without requiring structural changes to the underlying build, orchestration, or delivery services.

The WEP 200 includes various computing and data elements, examples of which are shown in FIG. 2. These elements generally exchange data over a network 201. A controller device 202A represents an authoring endpoint operated by a site controller. A user device 202B represents a consumption endpoint operated by a site user. Additional third-party developer devices 250 may interact with extension tooling.

One or more servers 210 enable centralized functionality associated with the WEP 200. The one or more servers 210 may correspond to the server 116 shown in FIG. 1. As such, the server 116 may perform the functionality described with respect to the one or more servers 210. Servers 210 further include API gateways 210A, orchestration modules 210B, build/compilation modules 210C, inference connector modules 210D, and edge-delivery modules 210E, each of which cooperate to perform request handling, background workflow, artifact generation, machine-learning integration, and content delivery network (CDN)-style dissemination, respectively. CMS 220 encloses API servers 230 and a content database 212B. Further, data sources 230 includes persistent stores, such as vector database 232A, platform database 232B, user DB 232C. A hosting system 240 exchanges prompt data and model output with one or more ML models 242.

In more detail, the site controller 204A may operate a controller device 202A (e.g., desktop computer, laptop, tablet, or similarly capable computing terminal). The controller device 202A executes an authoring application 202A-1 that communicates with WEP 200 over network 201. Using the authoring application 202A-1, the site controller may generate, import, or modify design-time assets (e.g., page structures, component libraries, style sheets, interaction timelines, and data bindings) and submit corresponding save, build, or publish requests to the servers 210. Controller device 202A may render the authoring application in a browser context, a native container, or another runtime environment, and may exchange design-and-or-maintain website-deployment data with the platform in real time or near-real time.

A site user 204B may operate a user device 202B (e.g., desktop computer, laptop, tablet, smartphone, set-top box) executing a runtime application 202B-1 that requests and renders published site assets delivered by the servers 210. The user device 202B may load static pages, dynamic CMS-backed content, e-commerce flows, membership-gated resources, or localized variants, depending on how the site was configured by the controller. Interactions initiated from the user device 202B may result in access-and-or-interact website-deployment data being exchanged with the servers 210, with optional personalization, authentication, or analytics processing performed along the way.

As shown in FIG. 2, the authoring application 202A-1 presents a designer interface 252 that provides access to visual tools enabling a site controller 204A to construct and/or alter a page 254 without direct manipulation of source code. Within interface 252 a component pane may surface reusable elements such as component 262, and a canvas or viewport may preview the evolving layout in real time. An ML interface 256 permits the site controller 204A to issue natural language prompts or other inputs to interact with the one or more models 242 via hosting system 240. Interface 256 may be implemented in various ways, such as a chat panel, voice overlay, multimodal widget, among others. Responsive model output may drive ML-assisted functions 258, which may include, for example, automatically generating page sections, refactoring existing component 262 for accessibility or localization, producing CMS-compatible schema suggestions, or inserting client-side logic templates. Depending on configuration, similar ML interfaces may also surface within runtime application 202B-1, allowing site users to obtain guided assistance or perform management tasks through conversational interaction.

One or more servers 210 operate as the execution core of WEP 200, receiving network traffic from external actor devices, coordinating internal workflows, invoking machine-learning resources, and emitting deployable or runtime assets. Although depicted as a single logical block, servers 210 may be implemented as a co-located cluster, a distributed micro-service mesh, or a cloud-hosted arrangement that scales elastically with demand.

The servers 210 incorporate a set of software modules configured to cooperate through message queues, RPC calls, or other service-bus mechanisms. At a high level API gateway modules 210A handle synchronous ingress. An orchestration tier (not shown in FIG. 2) manages background or long-running tasks. Build/compilation modules 210B convert design input into deployable artifacts. An inference connector layer 210C broker prompt exchanges with the hosting system 240. Edge delivery modules 210D stage static and dynamic resources for low-latency distribution. Each module may be containerized, serverless, or otherwise independently deployable, allowing updates to be rolled out without interrupting the WEP 200.

API gateway modules 210A perform various functions, such as terminating Transport Layer Security (TLS), validating JavaScript Object Notation (JSON) Web Tokens, and expose Representative State Transfer (REST), Graphical Query Language (GraphQL), or WebSocket interfaces that client applications call when saving designs, fetching CMS content, or running administrative queries. They may apply per-workspace or per-site rate limits, translate external resource identifiers into internal shard keys, and inject correlation metadata into each request for downstream tracing. In zero-trust configurations, the API gateway modules 210A may also perform mutual-TLS handshakes with edge nodes or developer command line interfaces (CLIs) before forwarding traffic onto the internal mesh.

Build/compilation modules 210B retrieve development snapshots, CMS bindings, and theme settings, then emit hashed asset bundles, pre-optimized image variants, framework-specific component libraries, and search-index manifests. A dependency graph may be used to identify pages or assets are invalidated by a change so that a full rebuild is avoided. Unchanged artifacts may also be linked from previous build versions. Output objects are written to a versioned S3-style bucket, tagged with a content hash and build-number metadata, and handed off to edge-delivery modules for global propagation.

Inference connector modules 210C assemble prompt payloads that may include design fragments, content snippets, schema fingerprints, and user-authored questions. The inference connector modules 210C may sign each request with a per-workspace API key, apply temperature or max-token policies set by workspace administrators, and/or dispatch prompts to an external model endpoint over authenticated (e.g., HTTP/2) channels. Inference connector modules 210C also parse received model output into typed actions, such as “generate component,” “rewrite copy,” or “suggest accessibility fix.” These parsed outputs may be queued back to orchestration modules or streamed directly to user devices.

Edge delivery modules 210D take artifacts produced by the build/compilation modules 210B and replicate them across geographically distributed points of presence. Assets may be version-pinned so a canary rollout may serve the new build to a percentage of traffic while the prior build remains active for the remainder. Edge workers may also execute JavaScript or WebAssembly to perform request-time tasks (e.g., cookie-based A/B routing, on-the-fly image resizing, or server-side rendering of personalized fragments before returning a response that is cached for subsequent requests).

The architecture of the servers 210 enable various applications of ML models 242 in relation to different web development workflows accessible through the WEP 200. In some implementations, the servers 210 enable an authoring workflow in which a newly added component is propagated from the design canvas to production in near real-time. For example, when a controller drags a “testimonial” component onto the canvas, the interface 252 emits a JSON delta via WebSocket to API-gateway modules 210A. Orchestration modules enqueue a build job, and the build/compilation modules 210B regenerate only the affected page bundle while reusing shared CSS and runtime libraries. Inference connector modules 210C send the component copy to ML models 242 (e.g., LLM) and requests tone-consistent rewrites. Model output data is then streamed back to the interface 252 for user review and approval. The edge delivery modules 210D pre-warm caches for the updated path, enabling publishing to be completed quickly (e.g., under a second).

In some implementations, the servers 210 enable a live component-refactor workflow that automates accessibility or structural updates across an existing site. A site controller 204A may type “convert nav bars to an accessible drop-down” into ML interface 256. In response, inference connector modules 210C package a prompt containing the site's navigation markup and audit results, retrieve refactored HTML and a, and forward the patch to build-and-compilation modules 210B. After incremental compilation, edge-delivery modules 210D push the new build while invalidating only nav-bar assets. A rollback pointer to the previous build is retained for instant reversion if post-publish tests fail.

In some implementations, the servers 210 enable an administrative guidance workflow that delivers conversational, ML-generated instructions for platform configuration tasks. For example, a site user 204B may interact with a voice widget to ask, “How do I enable multi-language support?” In this example, a voice clip may be transcribed on the user device 202B and posted to API-gateway modules 210A. Inference connector modules 210C query one or more ML models 242 (e.g., knowledge base aware model) that returns a checklist of localization steps plus one-click mutation calls. Orchestration modules then create a location workspace, build/compilation modules 210B obtain locale variants, and edge delivery modules 210D begin serving Accept-Language aware routes. This workflow allows the task to be completed without manual navigation through multiple settings screens.

CMS 120 manages structured content that populates pages, components, and dynamic lists served by WEP 200. The system lets a site controller define collections, fields, and localized variants, then stores and surfaces that content so that build and runtime processes may merge it with design artifacts. During machine learning workflows prompts may be enriched with relevant collection entries or schema information. Model output may be validated against the same schema to ensure that any generated markup stays coordinated with stored data.

CMS 220 further includes API servers 222 and content database 224. The API servers 222 expose read and write endpoints that the design canvas, build pipeline, and runtime site all consume. The content database 224 stores collection items, draft, locale variants, and reference links (e.g., in a multi-tenant partition so that different workspaces remain isolated). These elements of CMS 220 let other modules in WEP 200 (e.g., modules of servers 210) treat content as a typed data source rather than raw text.

API servers 222 may implement REST and GraphQL methods for creating collections, uploading media, managing localization, and querying entries at build or request time. Requests enter through API gateway modules 210A and are routed to the appropriate microservice shard. Each call is checked against workspace roles so that only authorized users or processes may insert or mutate content. The servers 210 also transmit events that orchestration modules may listen to in order to trigger incremental rebuilds or cache purges.

Content database 224 is a multi-region document store that persists collection schemas, field values, slug indexes, and locale mappings. Each write operation may be versioned, allowing rollback if a site controller 204A accidentally deletes or changes an entry. The content database 224 supports full-text and faceted search so that runtime pages may query on reference fields without loading entire collections. It also stores media metadata that edge delivery modules 210D may use for responsive image selection.

Interaction between API servers 222 and content database 224 may follow a strict commit path. For example, API servers 222 validate incoming payloads against collection schemas, transform the payloads into storage records, and write them to content database 224 in a transaction that ensures referential integrity. When data changes the servers publish a change event to orchestration modules. Build/compilation modules 210B may pull the updated entries, regenerate only the affected pages, and write new artifacts to the build repository. Edge delivery modules 210D receive a signed cache bust instruction so that users see the updated content without delay. This communication loop ensures design, content, and deployment states are aligned even when machine learning models generate or modify content through the same APIs.

Data sources 230 provide a storage layer that underpins content retrieval, machine learning context, and runtime personalization for WEP 200. Databases included in the database sources 230 may sit outside the servers 210 so it may scale storage capacity independently of compute demand. For example, read and write operations flow through API gateway 210A or orchestration tasks, and change events propagate to build or edge services so that newly stored records appear in published sites without manual intervention. During prompt generation, the inference connector 210C enriches requests with context fetched from these stores, and after model inference the same stores are updated or queried to confirm that generated output aligns with existing schemas.

Vector database 232A stores high-dimensional embeddings that represent component code snippets, CMS entries, design tokens, and knowledge base documents. The vector database 232A supports approximate nearest-neighbor search so the inference connector may retrieve semantically similar records in milliseconds. Embeddings are regenerated during build or on demand when a large batch of content changes. The store also tracks embedding versions so model prompts always receive context that matches the active design or content revision.

Platform database 232B holds project metadata such as workspace settings, build history, billing status, feature flags, and role assignments. Each workspace or site occupies a logical partition that isolates records while still allowing cross-workspace queries for administrative analytics. The database maintains foreign keys to build artifacts in object storage and to content items in CMS 220, which lets server modules assemble a complete view of a project without performing fan-out requests.

User database 232C records site member accounts, authentication tokens, membership tiers, and e-commerce order history. Access tokens generated by API gateway 210A map to rows in this store, allowing edge delivery modules 210D to evaluate gating rules during request processing. The user database 232C also captures engagement metrics such as last login time or page view counts, which may feed personalization or analytics dashboards.

The databases discussed above operate together through shared identifiers and event streams to maintain consistency across the platform. When a controller publishes a new collection item the CMS writes the entry to content database 224 and emits an event that triggers embedding generation in vector database 232A. The same event updates index pointers in platform database 232B so build modules may link the new content to its deployment record. If the item is member-restricted, a policy pointer is stored in user database 232C so edge delivery modules may enforce access at request time. This coordinated flow ensures that machine learning prompts receive up-to-date context, model output respects schema constraints, and published pages honor all access and personalization rules.

Hosting system 240 provides a managed inference service that receives prompt data from server modules and returns machine generated output used to augment website design, build, and runtime tasks. The hosting system 240 may allocate compute resources, schedule model workloads, enforce request quotas, and logs usage metrics. Prompt requests may include design fragments, CMS records, or visitor questions. Response payloads may contain generated code snippets, rewritten copy, layout suggestions, or operational guidance that the platform may apply without manual intervention.

Hosting system 240 integrates with the WEP 200 through a set of network accessible endpoints that may be reached by direct API calls, by cloud provider private links, or by a customer managed hosting arrangement. The inference connector 210C authenticates each request with an API key, signs payloads, and posts them to an endpoint path that selects a specific model or model version. The hosting system 240 may reside in a public cloud region, in a dedicated tenancy, or in an on-premise cluster that meets data residency requirements. Configuration flags allow workspace administrators to choose among these connectivity modes without changing application code.

Machine learning models 242 implement the inference logic that generates the information used by the WEP 200. The models may be large language models (LLMs) that excel at natural language generation, large action models (LAMs) that plan multi step tasks, or multimodal (MM) models that accept and emit combinations of text, code, or image embeddings. Each model may be versioned and measured for token usage, latency, and accuracy. The hosting system 240 may route traffic to a single model or to an ensemble of models depending on the prompt type and workspace policy.

Machine learning models 242 operate inside the hosting system 240 in containerized runtimes, e.g., runtimes that that expose uniform gRPC and REST interfaces. The hosting layer may handle model loading, weights decryption, warm-up sequences, and autoscaling. It also injects guardrail middleware that checks prompts for policy compliance and truncates or redacts disallowed content. Model output is streamed back to WEP 200 in an event format that preserves token order so the authoring canvas may display partial completions in real time.

As discussed above, the WEP 200 may be designed in various implementations to augment, improve, or streamline various aspects of website development using interactions with the one or more ML models 242. For example, a site controller 204A may access interface 252 on controller device 202A and enter a natural language prompt into ML interface 256 asking the platform to “generate a five page marketing site for a coffee brand with warm colors and bold headings.” Application 202A-1 then sends the prompt to API gateway modules 210A over network 201. Inference connector modules 210C forward the prompt to hosting system 240 which relays it to machine learning models 242. The ML models 242 return structured markup and component definitions that reference images and copy aligned with the request. Build/compilation modules 210B merge the generated markup with schema information pulled from content database 224 through API servers 222 so that every collection reference is valid. Edge delivery modules 210D publish the new artifacts and invalidate only the changed routes which lets user devices 202B immediately load the freshly created pages.

As another example, a site controller 204A may decide to localize the site for Spanish speaking visitors using the same workflow. The site controller 204A issues a prompt in interface 256 that requests translated versions of each collection item stored in content management system 220. API gateway modules 210A receive the prompt along with collection identifiers. Inference connector modules 210C assemble context by fetching the English records and related embeddings from vector database 232A then pass that context to machine learning models 242. The ML models 242 return translated field values which API servers 222 write as new locale variants in content database 224 while platform database 232B records a build dependency for each updated item. Build/compilation modules 210B regenerate only the localized bundles and edge delivery modules 210D tag them with Accept-Language rules so site users automatically receive the correct language version.

In yet another example, during ongoing operation a site user 204B signs in through application 202B-1 and asks an on-page chatbot how to schedule a product launch for next Friday. The question travels through network 201 to API gateway modules 210A and is passed to inference connector modules 210C with user context from user database 232C. Machine learning models 242 analyze the prompt and return a step list that includes creating a draft collection item, assigning a release date, and triggering a publish event. The response also contains signed mutation requests that API servers 222 may execute on behalf of the authenticated user. Orchestration logic writes the new item to content database 224, schedules a timed build in platform database 232B, and notifies build and compilation modules 210B to pre render the page. Edge delivery modules 210D queue a cache purge for the launch path so the new content appears exactly when the scheduled date arrives.

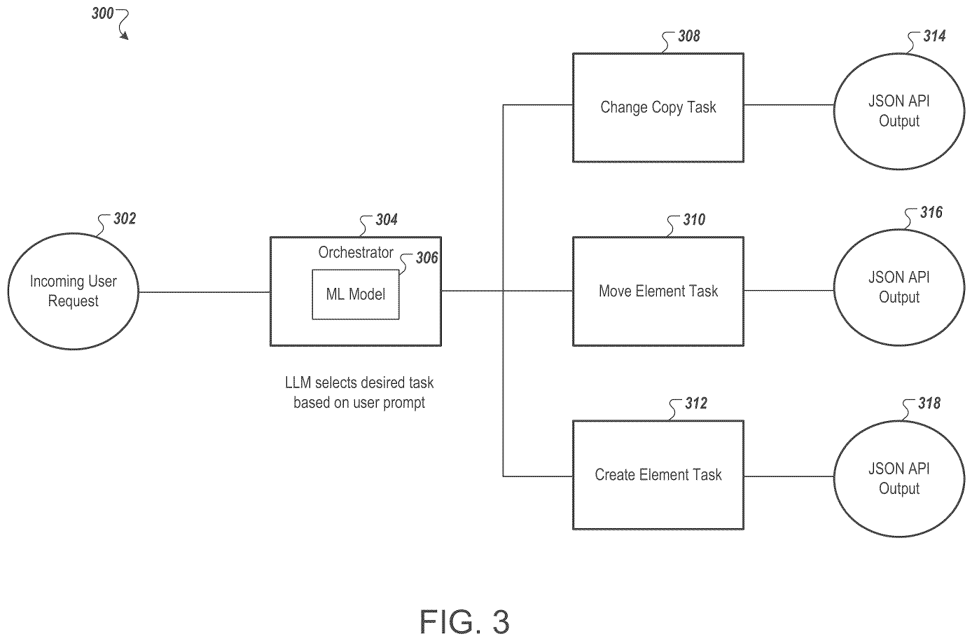

FIG. 3 is a block diagram 300 of another example technique for webpage modification using machine learning. The block diagram 300 illustrates one or more processes and one or more components that work collectively to perform a webpage modification. The processes described with respect to example FIG. 3 may be performed by the components of system 100 in FIG. 1.

At 302, the user provides an incoming request to modify a website currently displayed on the client device. The incoming request includes modifying a particular component or feature of the website. The orchestrator 304 prepares the processes, including the request from a user device, for communicating with the ML model 306. The ML model 306, which may include an LLM, selects one or more desired tasks to execute based on the submitted user request 302.

The example in system 300 illustrates three functions, e.g., change copy task 308, move element task 310, and create element task 312. In order to satisfy the user request 302, the ML model 306 may select one or more of the tasks, performance for one or more of the tasks in a desired order, and instructions associated with one or more of these tasks. These tasks may be executed in accordance with the output of the ML model 306 and corresponding output generated. For example, the change copy task 308 outputs a JSON API output 314, the move element task 310 outputs a JSON API output 316, and the create element task 312 outputs a JSON API output 318. Each of these outputs may be used for rendering an update to a webpage.

In some implementations, the ML model 306 may perform dynamic and intelligent edits on websites via a JSON interface. In one example, the ML model 306 receives natural language input from users, processes the input, and generates JSON-based instructions that modify the website's content, structure, or design. This technique removes the need for direct human manipulation of code or complex CMS environments and provides a more intuitive and accessible method for managing web content. Additionally, this technique enhances token efficiency by focusing on the changes needed, without repeating unnecessary information for the ML model 306.

In some implementations, the systems and techniques enable the following ML-assisted web development tasks. For example, a user enters a natural language description of a change the user wants to make to a part of their website, e.g., “Make the background color light gray.” The user entry is sent to an orchestration language model that has several web development tools available to choose from which are each custom built to make a specific type of change to a website (e.g., editing grids, changing copy, changing styles, changing the HTML structure of the page are tools that may be available to the orchestration layer). In this example, each web development tool may provide an additional ML model call that includes details about the user's site, styles, and content which informs the ML model 306 for that web development tool so that it may make desired changes with minimal input from the user.

In some implementations, the system 100 may be tested using numerous (e.g., hundreds) input prompts that are processed through the system to generate output results, which are then scored along three different metrics, including visual aesthetics, prompt adherence, and style reuse. Visual aesthetics may include reviewing how the generated section looks including whether it is well-formatted with good spacing and information hierarchy. Prompt adherence may include reviewing if the system correctly makes desired changes that are requested. Style re-use may include reviewing if existing styles were reused that were created by the user when making the desired change or if new styles were created which may clutter the user's site with unnecessary CSS declarations. Scores may be created through two separate methods, including manual scoring and automated scoring. Manual scoring may include having human evaluators manually go through dozens of results and measure each result based on the above criteria. Automated scoring may include using a language model that has been instructed how it should score each output based on each scoring dimension. Automated scoring models may then tuned to be more in line with the manual scores that human evaluators create.

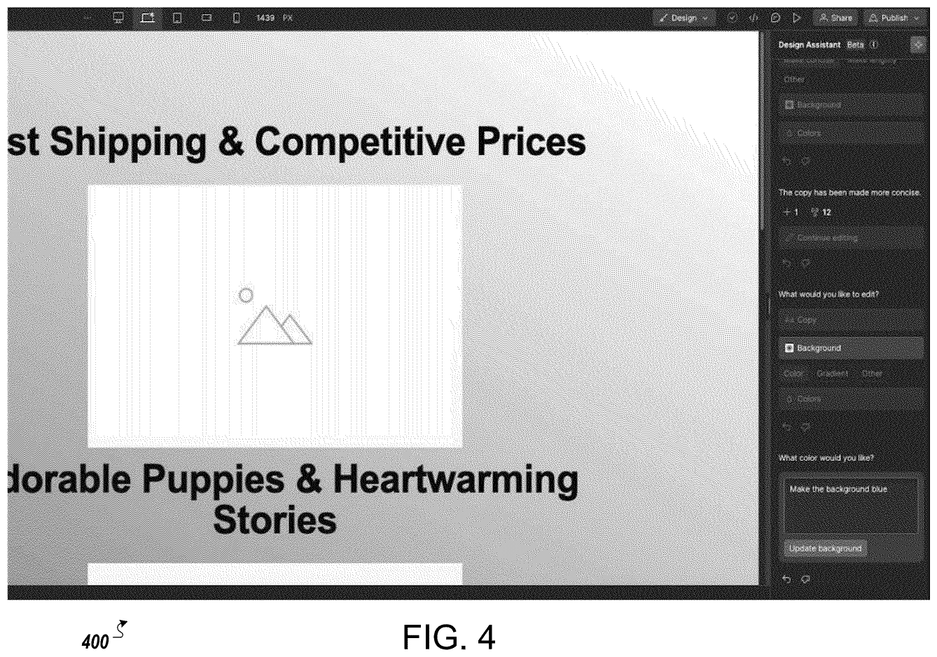

FIG. 4 is a block diagram of a user interface 400 that illustrates a chatbot for rendering webpage modifications. In particular, as shown on the user interface 400, the user may interact with a particular section and perform one or more modifications to that section. The modifications may include, for example, making a section more concise, changing a color scheme of that section, changing a gradient of that section, specifying a color, a button to update the background to a new color which triggers the processes of stages (A)-(O) in system 100 of FIG. 1, and other elements.

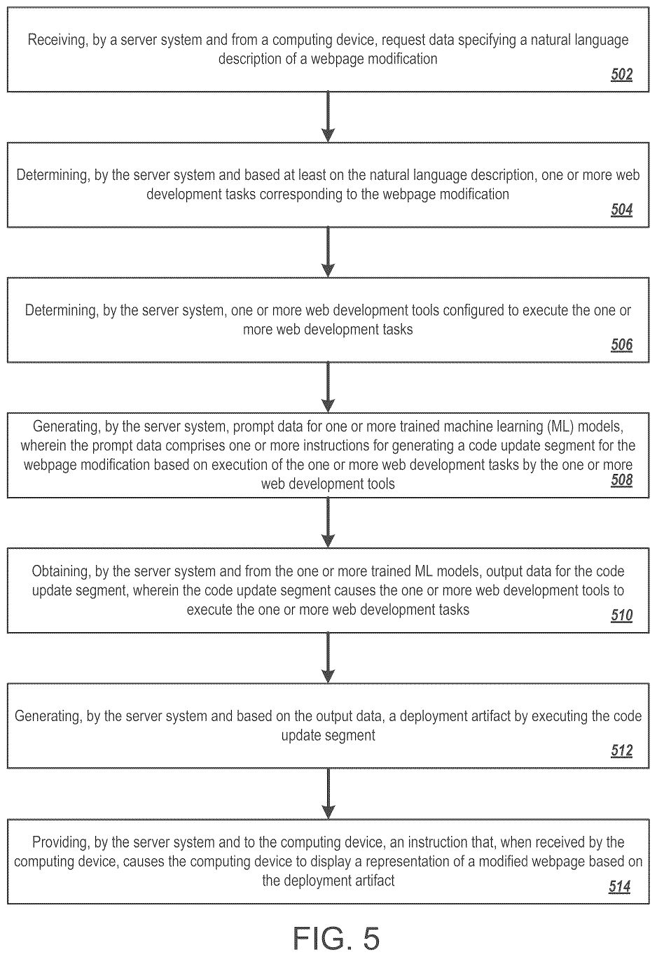

FIG. 5 is a flow chart illustrating an exemplary process 500 of modifying a webpage using machine learning. The server 116 of FIG. 1 may perform the process 500, for example.

During 502, the server may receive, from a computing device, request data specifying a natural language description of a webpage modification. The request data may specify a natural language description of the webpage modification and may include a selected section of a webpage on the computing device and one or more device attributes of the computing device. The server may receive the request data over a network.

During 504, the server may determine, based at least on the natural language description, one or more web development tasks corresponding to the webpage modification. Determining the one or more web development tasks further includes the server extracting, from the request data, data identifying a section of a webpage associated with the webpage modification. The server may retrieve a current state of the identified section of the webpage. The server may determine the one or more web development tasks based on the current state of the identified section. The webpage modification includes at least one of a change to a background color of the webpage, a change to a style of the webpage, a change to a layout structure of the webpage, or a summary of content currently presented on the webpage.

Moreover, the server may obtain user history data specifying a set of webpage modifications previously submitted by a user associated with the computing device. Determining the one or more web development tasks corresponding to the webpage modification includes the server identifying a particular set of web development tasks associated with the set of webpage modifications previously submitted by the user and the server selecting a subset of web development tasks based on the particular set of web development tasks.

During 506, the server may determine one or more web development tools configured to execute the one or more web development tasks. The one or more web development tools include at least one of a style modification tool, a content update tool, a grid layout tool, or an HTML structure modification tool. Determining the one or more web development tools configured to execute the one or more web development tasks includes the server identifying a particular set of web development tools associated with the set of webpage modifications previously submitted by the user and the server selecting a subset of web development tools based on the particular set of web development tools. Moreover, determining the one or more web development tools configured to execute the one or more web development tasks includes the server generating a semantic index based on the natural language description of the webpage modification, identifying a set of application programming interface (API) tools specified in a content management system, and selecting a subset of API tools from among the set of API tools based on the semantic index.

During 508, the server may generate prompt data for one or more trained machine learning (ML) models, the prompt data includes one or more instructions for generating a code update segment for the webpage modification based on execution of the one or more web development tasks by the one or more web development tools.

During 510, the server may obtain, from the one or more trained ML models, output data for the code update segment, the code update segment causes the one or more web development tools to execute the one or more web development tasks.

During 512, the server may generate, based on the output data, a deployment artifact by executing the code update segment. The deployment artifact specifies at least one of a text segment for modified content of the webpage, one or more graphical user interface (GUI) elements for modified content of the webpage, or metadata that describes modified content of the webpage.

During 514, the server may provide, to the computing device, an instruction that, when received by the computing device, causes the computing device to display a representation of a modified webpage based on the deployment artifact. The representation of the modified webpage includes a difference view that identifies one or more edits between a current state of the webpage and the content modification.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification may be realized in digital electronic circuitry, in tangibly-embodied computer software or firmware, in computer hardware, including the structures disclosed in this specification and their structural equivalents, or in combinations of one or more of them. Implementations of the subject matter described in this specification may be implemented as one or more computer programs (e.g., one or more modules of computer program instructions) encoded on a tangible non-transitory storage medium for execution by, or to control the operation of, data processing apparatus. The computer storage medium may be a machine-readable storage device, a machine-readable storage substrate, a random or serial access memory device, or a combination of one or more of them. The program instructions may be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus may also be, or further include special purpose logic circuitry (e.g., an FPGA (field programmable gate array) or an ASIC (application-specific integrated circuit)). The apparatus may optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, may be written in any form of programming language, including compiled or interpreted languages, or declarative or procedural languages; and it may be deployed in any form, including as a stand-alone program or as a module, component, subroutine, or other unit suitable for use in a computing environment. A program may, but need not, correspond to a file in a file system. A program may be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines may be installed and running on the same computer or computers.

The processes and logic flows described in this specification may be performed by one or more programmable computers executing one or more computer programs to perform functions by operating on input data and generating output. The processes and logic flows may also be performed by special purpose logic circuitry (e.g., a FPGA, an ASIC), or by a combination of special purpose logic circuitry and one or more programmed computers.

Computers suitable for the execution of a computer program may be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory may be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification may be provisioned on a computer having a display device (e.g., a CRT (cathode ray tube) or LCD (liquid crystal display) monitor) for displaying information to the user and a keyboard and a pointing device (e.g., a mouse, a trackball), by which the user may provide input to the computer. Other kinds of devices may be used to provide for interaction with a user as well; for example, feedback provided to the user may be any form of sensory feedback (e.g., visual feedback, auditory feedback, tactile feedback); and input from the user may be received in any form, including acoustic, speech, or tactile input. In addition, a computer may interact with a user by sending documents to and receiving documents from a device that is used by the user; for example, by sending web pages to a web browser on a user's device in response to requests received from the web browser. Also, a computer may interact with a user by sending text messages or other forms of message to a personal device (e.g., a smartphone that is running a messaging application), and receiving responsive messages from the user in return.

Data processing apparatus for implementing machine learning models may also include, for example, special-purpose hardware accelerator units for processing common and compute-intensive parts of machine learning training or production (e.g., inference, workloads).

Machine learning models may be implemented and deployed using a machine learning framework (e.g., a TensorFlow framework, a Microsoft Cognitive Toolkit framework, an Apache Singa framework, an Apache MXNet framework).

Implementations of the subject matter described in this specification may be realized in a computing system that includes a back-end component (e.g., as a data server) a middleware component (e.g., an application server), and/or a front-end component (e.g., a client computer having a graphical user interface, a web browser, or an app through which a user may interact with implementations of the subject matter described in this specification), or any combination of one or more such back-end, middleware, or front-end components. The components of the system may be interconnected by any form or medium of digital data communication (e.g., a communication network). Examples of communication networks include a local area network (LAN) and a wide area network (WAN) (e.g., the Internet).

The computing system may include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) may be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially be claimed as such, one or more features from a claimed combination may in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving, by a server system and from a computing device, request data specifying a natural language description of a webpage modification;
determining, by the server system and based at least on the natural language description, one or more web development tasks corresponding to the webpage modification;
determining, by the server system, one or more web development tools configured to execute the one or more web development tasks;
generating, by the server system, prompt data for one or more trained machine learning (ML) models, wherein the prompt data comprises one or more instructions for generating a code update segment for the webpage modification based on execution of the one or more web development tasks by the one or more web development tools;
obtaining, by the server system and from the one or more trained ML models, output data for the code update segment, wherein the code update segment causes the one or more web development tools to execute the one or more web development tasks;
generating, by the server system and based on the output data, a deployment artifact by executing the code update segment; and
providing, by the server system and to the computing device, an instruction that, when received by the computing device, causes the computing device to display a representation of a modified webpage based on the deployment artifact.

2. The method of claim 1, wherein the one or more web development tools comprise at least one of a style modification tool, a content update tool, a grid layout tool, or an HTML structure modification tool.

3. The method of claim 1, further comprising:
obtaining, by the server system, user history data specifying a set of webpage modifications previously submitted by a user associated with the computing device; and
wherein determining the one or more web development tasks corresponding to the webpage modification comprises:
identifying a particular set of web development tasks associated with the set of webpage modifications previously submitted by the user, and
selecting a subset of web development tasks based on the particular set of web development tasks.

4. The method of claim 3, wherein determining the one or more web development tools configured to execute the one or more web development tasks comprises:
identifying a particular set of web development tools associated with the set of webpage modifications previously submitted by the user; and
selecting a subset of web development tools based on the particular set of web development tools.

5. The method of claim 1, wherein the webpage modification comprises at least one of a change to a background color of the webpage, a change to a style of the webpage, a change to a layout structure of the webpage, or a summary of content currently presented on the webpage.

6. The method of claim 1, wherein determining the one or more web development tasks further comprises:
extracting, by the server system and from the request data, data identifying a section of a webpage associated with the webpage modification;
retrieving, by the server system, a current state of the identified section of the webpage; and
determining the one or more web development tasks based on the current state of the identified section.

7. The method of claim 1, wherein:
determining the one or more web development tools configured to execute the one or more web development tasks comprises:
generating a semantic index based on the natural language description of the webpage modification;
identifying a set of application programming interface (API) tools specified in a content management system; and
selecting a subset of API tools from among the set of API tools based on the semantic index.

8. The method of claim 1, wherein generating the deployment artifact by executing the code update segment comprises:
executing each web development tool included in the one or more web development tools;
obtaining tool output data based on executing each web development tool included in the one or more web development tools, wherein the tool output data combines respective tool outputs associated with each of the one or more web development tools;
generating content modification data based on the tool output data; and
formatting the content modification data to generate the deployment artifact.

9. The method of claim 8, wherein the deployment artifact specifies at least one of (i) a text segment for modified content of the webpage, (ii) one or more graphical user interface (GUI) elements for modified content of the webpage, or (iii) metadata that describes modified content of the webpage.

10. The method of claim 8, wherein the representation of the modified webpage comprises a difference view that identifies one or more edits between a current state of the webpage and the content modification.

11. A system comprising:
one or more computers; and
one or more storage devices storing instructions that are operable, when executed by the one or more computers, to cause the one or more computers to perform operations comprising:
receiving, by a server system and from a computing device, request data specifying a natural language description of a webpage modification;
determining, by the server system and based at least on the natural language description, one or more web development tasks corresponding to the webpage modification;
determining, by the server system, one or more web development tools configured to execute the one or more web development tasks;
generating, by the server system, prompt data for one or more trained machine learning (ML) models, wherein the prompt data comprises one or more instructions for generating a code update segment for the webpage modification based on execution of the one or more web development tasks by the one or more web development tools;
obtaining, by the server system and from the one or more trained ML models, output data for the code update segment, wherein the code update segment causes the one or more web development tools to execute the one or more web development tasks;
generating, by the server system and based on the output data, a deployment artifact by executing the code update segment; and
providing, by the server system and to the computing device, an instruction that, when received by the computing device, causes the computing device to display a representation of a modified webpage based on the deployment artifact.

12. The system of claim 11, wherein the one or more web development tools comprise at least one of a style modification tool, a content update tool, a grid layout tool, or an HTML structure modification tool.

13. The system of claim 11, further comprising:
obtaining, by the server system, user history data specifying a set of webpage modifications previously submitted by a user associated with the computing device; and
wherein determining the one or more web development tasks corresponding to the webpage modification comprises:
identifying a particular set of web development tasks associated with the set of webpage modifications previously submitted by the user, and
selecting a subset of web development tasks based on the particular set of web development tasks.

14. The system of claim 13, wherein determining the one or more web development tools configured to execute the one or more web development tasks comprises:
identifying a particular set of web development tools associated with the set of webpage modifications previously submitted by the user; and
selecting a subset of web development tools based on the particular set of web development tools.

15. The system of claim 11, wherein the webpage modification comprises at least one of a change to a background color of the webpage, a change to a style of the webpage, a change to a layout structure of the webpage, or a summary of content currently presented on the webpage.

16. The system of claim 11, wherein determining the one or more web development tasks further comprises:
extracting, by the server system and from the request data, data identifying a section of a webpage associated with the webpage modification;
retrieving, by the server system, a current state of the identified section of the webpage; and
determining the one or more web development tasks based on the current state of the identified section.

17. The system of claim 11, wherein:
determining the one or more web development tools configured to execute the one or more web development tasks comprises:
generating a semantic index based on the natural language description of the webpage modification;
identifying a set of application programming interface (API) tools specified in a content management system; and
selecting a subset of API tools from among the set of API tools based on the semantic index.

18. The system of claim 11, wherein generating the deployment artifact by executing the code update segment comprises:
executing each web development tool included in the one or more web development tools;
obtaining tool output data based on executing each web development tool included in the one or more web development tools, wherein the tool output data combines respective tool outputs associated with each of the one or more web development tools;
generating content modification data based on the tool output data; and
formatting the content modification data to generate the deployment artifact.

19. The system of claim 18, wherein the deployment artifact specifies at least one of (i) a text segment for modified content of the webpage, (ii) one or more graphical user interface (GUI) elements for modified content of the webpage, or (iii) metadata that describes modified content of the webpage.

20. One or more non-transitory computer-readable media storing software comprising instructions executable by one or more computers which, upon such execution, cause the one or more computers to perform operations comprising:
receiving, by a server system and from a computing device, request data specifying a natural language description of a webpage modification;
determining, by the server system and based at least on the natural language description, one or more web development tasks corresponding to the webpage modification;
determining, by the server system, one or more web development tools configured to execute the one or more web development tasks;
generating, by the server system, prompt data for one or more trained machine learning (ML) models, wherein the prompt data comprises one or more instructions for generating a code update segment for the webpage modification based on execution of the one or more web development tasks by the one or more web development tools;
obtaining, by the server system and from the one or more trained ML models, output data for the code update segment, wherein the code update segment causes the one or more web development tools to execute the one or more web development tasks;
generating, by the server system and based on the output data, a deployment artifact by executing the code update segment; and
providing, by the server system and to the computing device, an instruction that, when received by the computing device, causes the computing device to display a representation of a modified webpage based on the deployment artifact.
